(19) United States
(12) Patent Application Publication
(10) Pub. No.: US 2008/0189000 A1
(43) Pub. Date: Aug. 7, 2008

(54) Detectable anti-collision automatic braking device for transportation

(76) Inventor: Henri Duong, Alhambra, CA (US)

Correspondence Address: Henri Duong, 316 1/2 E Glendon way, Alhambra, CA, 91801, US

(21) Appl. No.: 11/982,774

(22) Filed: Nov. 5, 2007

(30) Foreign Application Priority Data
Feb. 2, 2007 (FR) 07/01466
Jun. 12, 2007 (GB) 0713096.6

(51) Int. Cl. G06F 19/00; G05D 13/00; G08G 1/00

(52) U.S. Cl. 701/20; 340/928; 701/70

(57) ABSTRACT

Detectable anti-collision automatic braking device for stopping traffic accident is invented installing for/in engine/motor-vehicles, automobiles, cars, trucks, buses, vans, trains, high speed trains, underground trains, tanks, motorcycles, airplanes, ships, helicopters, submarines and all moving transportations to apply braking automatically by itself against obstacle to stop collision averting traffic accident during transportation running and as well for adapting in use Automatic traffic stop lamp device of a security system equipping on traffic signal or in area nearby, its beam will flash at lighting zone limit on red at a position to focus on to react the function of Detectable anti-collision automatic braking devices of all front motor-vehicles, transportations that approach to stop without surpassing limit zone.

### CROSS-REFERENCE TO RELATED APPLICATION

U.S. patent application Ser. No. 09/943,930 filing date Aug. 27, 2001, US Class no. 303/193, International Class no. B60T 008/32

Disclosure Document Deposit Request no. 503812 date Jan. 18, 2002 and no. 528018 date Mar. 17, 2003

U.S. patent application Ser. No. 11/499,092 filing date Aug. 4, 2006

Continuation/succession of U.S. patent application Ser. No. 10/725,226 filing date Dec. 1, 2003, US Class no. 303/191, International Class no. B60T 8/32 20060101 B60T008/32

French INPI patent application Ser. No. 07/01466 filing date Feb. 2, 2007 France

UKIPO Patent Application no. GB 0801564.6 a division of Patent Application no. 0713096.6 filing date Jun. 12, 2007 United Kingdom

### STATEMENT REGARDING FEDERALLY SPONSORED RESEARCH

“Not Applicable”

### REFERENCE TO A MICROFICHE APPENDIX

“Not Applicable”

### BACKGROUND OF THE INVENTION

Automatic Braking Device was formerly filed under U.S. patent application Ser. No. 09/943,930 filing date Aug. 27, 2001 and U.S. patent application Ser. No. 10/725,226 filing date Dec. 1, 2003, the second petition was in final process but failed to overcome statutory time period for allowance even though the revival and appeal petitions were made but in vain to waive 42.500 Americans being killed yearly by traffic accidents in the United States of America where the invention would resolve to secure them by its merit. My present petition is filed as succession of my previous applications.

Detectable Anti-collision Automatic Braking Device is invented in use for/in engine/motor-vehicles, automobiles, cars, trucks, buses, vans, trains, high speed trains, underground trains, tanks, motorcycles, airplanes, ships, helicopters, submarines and all moving transportations as anti-collision system for stopping collision and traffic accident during transportation running to save human lives but today's motor-vehicle/transportation does not possess such device. Structures of Detectable Automatic Braking Device are created for purpose of fitting different types and structures of motor-vehicles and transportations in automobile and transportation in all manufacturing industries, and as well for adapting in use Automatic traffic stop lamp device; a security system is for equipping on traffic signal on the route to stop all front motor-vehicles/transportations approaching on red without surpassing zone limit by reacting the functions of their Detectable automatic braking devices being installed in transportations.

### BRIEF SUMMARY OF THE INVENTION

Solutions of the invention(s) in motor-vehicle/transportation running contain for:

protecting and saving human lives from traffic accidents

stopping collision averting from traffic accident involvement

protecting material from traffic accident damages

stopping all motor vehicles on red without surpassing specific limit zone

The system composes of Detectable Anti-collision Automatic Braking Device using for engine/motor-vehicles, automobiles, cars, trucks, buses, vans, trains, high speed trains, underground trains, tanks, motorcycles, airplanes, ships, helicopters, submarines, all moving transportations, anti-collision system, structural operational links & automatic braking unit(s)/motor(s), detection in/on all transportation driving, speedometer switch, voice recorder, lowering speed unit, automatic safety system, automatic brake releasing & locking unit, automatic water switch, entire braking network, electrical circuit, control unit, radars, sensors, frequency devices, infrared lenses, cameras, projectors, electronic eyes, lighting/motion sensors, sensor video cameras, electromagnetic beam/ray, electromagnetic/radio waves of frequency devices, similarity, detectable devices and/or ready-made devices in use having capacity to detect and respond by detected result/transmitting & receiving (radio) frequency signals against obstruction, electric wire/wireless, facilities of anti-snow and anti-light flashing, braking equipments/facilities including motors, any energy, compressed air/wind force, air hydraulic/oxygen unit, air/liquid pump, cylinder as nut & piston as bolt, induction coils, spring force, equipments/instruments having braking result, braking objects including wheel, spindle, axis, rod, bracket drive, any others, triangle wheels, round wheels, oval wheels, hexagonal wheels, wheels of all sorts, inner wheels of all sorts, ball bearings, roller bearings, pins, arms, moving balls, frames, lock iron switches, switch devices, switches, lock devices, bracket arms, springs, rewind springs, iron bars, brackets, bars, frames with bars, frames with moving balls, screw & unscrew toothed spindles, frames with gear-nuts, axis-gears, axis in groove end part, gears, frames with short tube outlets, extra rod outlet, connecting rod kit, moving frame, spring air releasing unit, rubber cover wheel in double pulley, oscillator, hose, direct spin bracket drive, hidden frame, rectangular bracket, frame cavity, mini-motors, cable, frame outlet, pulley, timing belt, gear unit, braking unit with grooved part, spring force, valve with inner vane, compressed air, pipes, braking rod, air cylinder, brake cylinder, air pump, timer, contacts, buttons for driver use, sonorous color signal lamps, thermostats, voice recorders, different brake pedals, rubber boots, safety covers, automatic brake pedals, signal lamp switch, switch of steering wheel, sensor/radar of adjustable direction, bearing with steering wheel spin, axis gear links of division, switch container, indicator, switch of signal lamp, signal lamp aside box, automatic traffic stop lamp device, lamps/bulbs, necessary parts, accessories, the base, grounds, composition, function, structures, method and process of making, inventing, contents, illustrations, connection, extension, combination, operation, using, installation, production, addition/reduction part/unit of the invention, the specific and extra uses of the invention, putting basis of the invention(s) into practice, energy for functioning, material(s) for making, modifications, replacement of parts, the original fundamentals of the invention(s) equipment/instrument carried by driver/sailor/pilot/others in transportation functioning the invention, comprising using processor, programmer, computer and/or similarity in the invention, using satellite operating network in the invention, combining the invention with any other entity including devices, equipments, instruments, objects and/or systems.

### BRIEF DESCRIPTION OF THE DRAWINGS

FIG. 1: Triangle wheel is equipped with motor

FIG. 2: Structure Duo (7A, 7B)

FIG. 3: Structure Du (7A, 7B)

FIG. 4: Structure Du (7B )

FIG. 5: Round wheel structure Duo-A

FIG. 6: Round wheel structure Duo-a

FIG. 7: Screw & Unscrew structure Duo-B

FIG. 8: Axis-gear structure Duo-C

FIG. 9: Extra outlet with rod structure Duo-D

FIG. 10: Moving frame structure Duo-E

FIG. 11: Bracket drive structure Duo-F

FIG. 12: Direct spin structure Duo-G

FIG. 13: Oval wheel structure Duo-H

FIG. 14: Hexagonal wheel structure Duo-I

FIG. 15: Air pump structure Duo-J

FIG. 16: Entire braking system network

FIG. 17: Electrical circuit

FIG. 18: Functioning of Automatic braking system

FIG. 19: Red or yellow lamp and its function

FIG. 20: Safe protection cover

FIG. 21: Various types of new pedals

FIG. 22: Automatic brake releasing and braking motors

FIG. 23: Automatic braking pedals

FIG. 24: Speedometer switch and radar(s)/sensor(s)

FIG. 25 : Automatic water switch

FIG. 26: Automatic stop control lamp

### DETAILED DESCRIPTION OF THE INVENTION

Detectable anti-collision automatic braking device is invented for stopping traffic accident/collision in transportation during running; comprising sensor(s)/radar(s) or similarity is for installing in/on engine/motor-vehicles, automobiles, cars, trucks, buses, vans, trains, high speed trains, underground trains, tanks, motorcycles, airplanes, ships, helicopters, submarines and all moving transportations connecting on “standby” for front and rear detecting at specified distance on the road, on railway, on air route and/or at/in sea, automatic braking is operated automatically during running based on both functions of sensor(s)/radar(s)/any operative device(s) detecting against obstruction at its detecting zone and of structural automatic braking unit being installed in/on transportation and connected electrically switching on by equipped sensor(s)/radar(s) that motor-vehicle/transportation is stopped running to avert collision grounds, comprising installing as parts of the invention(s) with detecting device in/on all transportation for safe driving, disconnecting function period, automatic water switch, speedometer switch unit, automatic braking unit(s) & structural operation links, automatic brake locking & releasing unit, automatic brake pedal, automatic safety system, operating lamps shown on indicator(s) and electrical, technical & mechanical connections in function grounds as well for adapting Automatic traffic stop lamp device in use, in characteristic process including that:

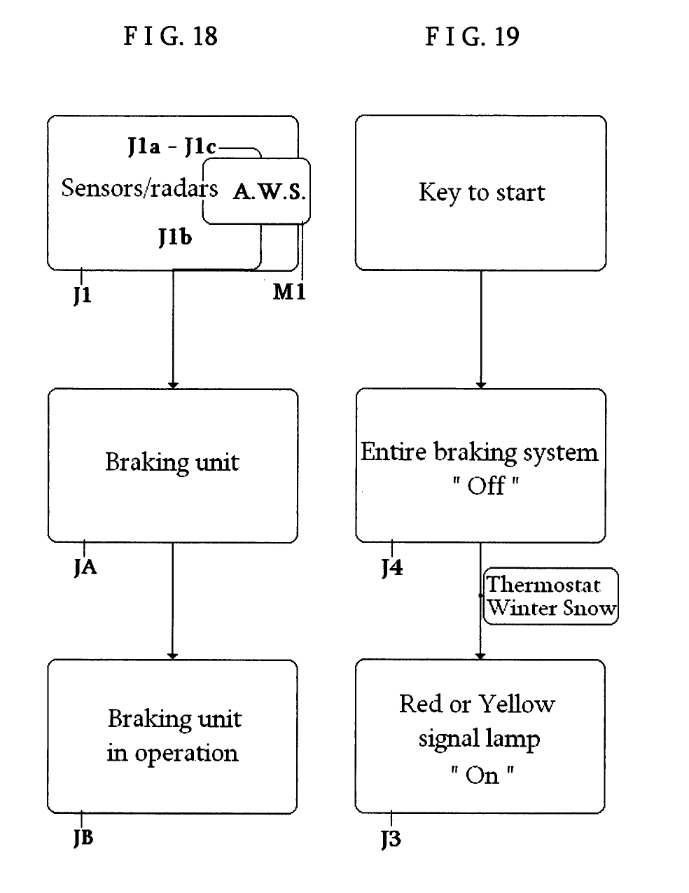

As a part of the invention(s), use and installation of detection in/on all transportation for safe driving: Comprising sensor(s)/radar(s) J1 (J1a-J1b and M1), infrared detecting lenses, electronic eyes, lighting/motion sensors, video cameras, electromagnetic beam/ray, electromagnetic/radio waves of frequency devices, detectable devices and/or ready-made devices in use having capacity to detect and respond by detected result against obstruction/transmitting & receiving (radio) frequency signals against obstacle under detecting/operating zone comprises to install in use for/on/in motor-vehicle/transportation connected to switch braking motor/unit JA on automatically to perform automatic braking JB during running on FIG. 18. Its connection comprising key starting contact is connected electric wires to sensor(s)/radar(s)/similarity switching it on “stand-by” during running.

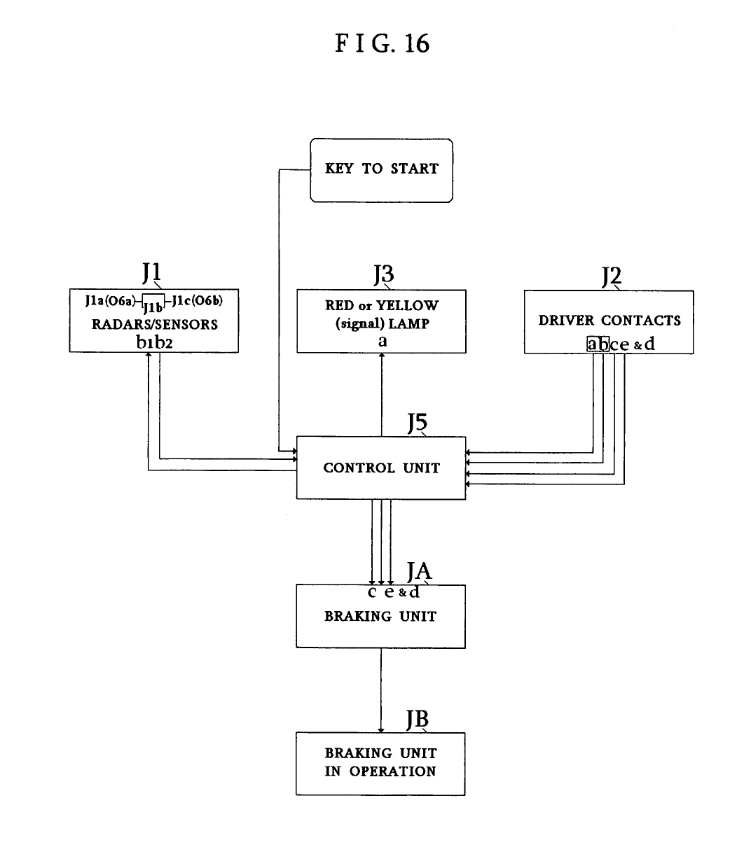

As a part of the invention(s), use and installation of detection in/on all transportation for safe driving: Comprising sensors/radars/detectable devices J1 having capacity for detecting both vehicle as well as human body containing anti-snow and anti-light flashing facilities comprises to install in use for/on/in motor-vehicle/transportation for front J1a(O6a)-J1c(O6b) and rear J1b detecting at specified distance during running, rear sensor(s)/radar(s)/similarity is connected through rear lamp switch being switched on during backing to perform automatic braking in function JB against obstacle on FIG. 16, 24. Its connection comprising any ready-made devices have technical capacity used for the invention, and anti-snow facilities include sensor(s)/radar(s)/similarity being housed in certain heating/head lamp transparent boxes.

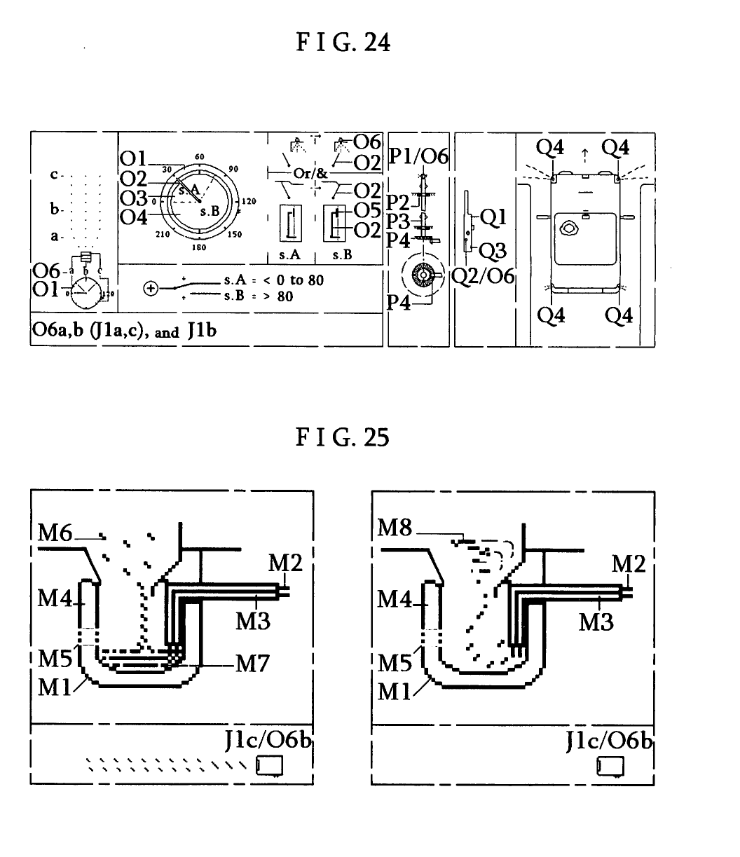

As a part of the invention(s), use and installation of detection in/on all transportation for safe driving: Motor-vehicle turns right/left to avert front sensor(s)/radar(s) and automatic braking device functioning against opposite vehicle during running comprising (1) either signal lamp switch or a switch at steering wheel is connected for switching front sensor(s)/radar(s) off, or (2) front sensor(s)/radar(s)/similarity P1/O6 having adjustable direction is mounted/fixed on an axis centered in ball bearing P2 framed in motor-vehicle/transportation, axis P3 part is linked gear P4 to gear of steering wheel/its division rotating at its direction that front sensor(s)/radar(s) can turn right or left on FIG. 24. Its connection comprising for either signal lamp switch or a switch is connected electric wires to front sensor(s)/radar(s)/similarity to be switched it on/off, and key starting contact is connected electric wires to sensor(s)/radar(s)/similarity by switching it on “stand-by” during running.

As a part of the invention(s), disconnecting Detectable anti-collision automatic braking device functioning for/in all transportation at starting and parking period: Comprising speedometer switch is used to disconnect electrically sensor(s)/radar(s)/detectable device(s) functioning in motor-vehicle/transportation comprising at lowest speed to let driver of motor-vehicle/transportation both leave parking area and park one's vehicle in parking area and/or key contact is connected a timer with preset time/manual timing action to postpone sensor(s)/radar(s)/detectable device(s) functioning to that effect.

As a part of the invention(s), automatic water switch M1: It is connected during running by raining M6 water M7 in an opening outlet M5 switch-container M4 between isolated M3 electric wires M2 of second front sensor(s)/radar(s)/similarity J1c/O6b of specified longer distance detection and those of automatic braking motor/unit in motor-vehicle/transportation which is to be stopped running on wet earlier against obstacle during raining, extinguishing connection is by wind M8 drying on it after raining is over as lamp indicator shown on FIG. 25. Its connection comprising key starting contact/driver contact is connected electric wires to automatic water switch by switching it on, it is proposed to be fixed in front flat part of motor-vehicle/transportation having opening for rain flowing in and wind blowing facility into the small switch-reservoir where electric wires are set inside for connecting shown on driver's lamp indicator and its upper part has opening outlet letting water flow out at full level.

As a part of the invention(s), speedometer switch unit comprising functioning with third front sensor/radar/similarity; speedometer as a switch O1; its pointer O2 conducts comprising electrically indicator front/rear surface O5 at high speed O4 as superior to 80/any O3 depending on country law or sensor/radar is installed using to detect speedometer pointer at high speed zone appeared on indicator to react functioning, so (third) front sensor/radar/similarity O6c is connected in motor-vehicle/transportation to detect at the specified longest distance against obstacle during running connecting (1) sonorous signal lamp/voice recorder sounding driver/pilot/sailor to lower motor-vehicle/transportation speed or change direction at the earliest among other radars to avert automatic braking, of automatic voice sound, and/or (2) either automatic braking unit or a second braking unit without lock applying braking to lower motor-vehicle/transportation speed safely, of automatic lowering speed. Its connection comprising electric wires of (third) sensor/radar and sonorous signal lamp/voice recorder/automatic braking unit of one pole are connected to speedometer pointer and the other pole of them to battery, electric wires of battery of one pole are connected to speedometer indicator front/rear surface at high speed zone/any of speedometer switch, for speedometer pointer conducting electrically to indicator surface at high speed zone comprising electronic/digital/similar connection on FIG. 24, sensors/radars/similarities are installed detecting on top, down and both sides of airplane, helicopter, submarine and both sides of ship at direction changing.

As a part of the invention(s), use and installation of detection in/on all transportation for safe driving: Comprising (1) sensors/radars are installed at right and left mirror sides of motor-vehicle and transportation for back and aside detecting at a distance during running, connecting signal lamp to switch it on during turning to sonorous signal lamp/voice recorder sounding driver against obstacle at a distance, (2) sensors/radars Q4 are installed aside of right and left sides comprising at/in each signal lamp box of motor-vehicle and transportation detecting aside person/car while driving out on driveway under function of a switch connecting sonorous signal lamp indicator/voice recorder to sound driver and/or react automatic braking against obstacle on FIG. 24. Its connection comprising for (1) signal lamp switches (R & L) are connected electric wires accordingly to right and left sensors/radars/similarities linking electrically to sonorous signal lamp/voice recorder which will sound by detected result of sensors/radars/detecting devices against rear vehicle in its detecting zone, (2) it is the same as above connection by adding a switch/contact in use.

As a part of the invention(s), use and installation of detection in/on all transportation for safe driving: Comprising (1) sensors/radars/similarities are installed at both sides of motor-vehicle/transportation for detecting extremely approaching running vehicles during running, connecting sonorous signal lamp/voice recorder to sound right or left side under detection shown on indicator, (2) sensors/radars/similarities Q2 are equipped at/by rear parts of doors Q1 in motor-vehicle, transportation at sides of driver and passenger(s) behind for back detecting approaching vehicle during door Q1 slightly opening to avert possible accident, sonorous lamp connected battery to sound driver, second sensors/radars Q3 are installed at door/opposite side on detecting at distance against vehicle/transportation chair/frame to switch sensor(s)/radar(s) Q2 off without sounding once door is widely open far beyond detection, using for motor-vehicle parking on the side of the road on FIG. 24. Its connection comprising for (1) key starting contact is connected electrically wire/wireless to both side sensors/radars/similarities to sonorous signal lamp/voice recorder which will sound against approaching running vehicles in detecting zone, (2) sonorous lamp is connected electric wires of one pole through sensor(s)/radar(s)/detecting device(s) Q2 to battery and electric wires of the other pole of both sonorous lamp and sensor(s)/radar(s)/detecting device(s) Q2 are connected through the other sensor(s)/radar(s)/detecting device(s) Q3 to battery on FIG. 24.

As a part of the invention(s), automatic braking unit & structural operation links: Comprising (1) automatic braking is operated by appropriate motor, induction coils, air/liquid pump, compressed air/wind force, air hydraulic/oxygen unit, spring force and/or movement caused by any energy/way, (2) braking objects are used as pedal extension part, automatic brake pedal, wheel, spindle, axis, bracket, cylinder as nut & piston as bolt, equipment, instrument and/or any structural ways by pressing/pulling to braking outlet rod/part/similarity, (3) switch is for turning brake motor/similarity off at point in braking prior to locking brake, (4) lock device is for locking the brake braking firmly to its braking object and/or any, (5) brake is released drawing lock device by a mini-motor rotating automatically/manual button switch to unlock the brake under motor rewind spring, spring, double rotating motor and/or any, (6) braking motor is fixed with supporting springs at specific moving position, an appropriate motor will rotate braking fast enough, a double rotating motor should have low speed at back spin, (7) it includes general electrical, technical & mechanical connections and making comprising operating in its logical order and (8) it refers to the degree of speed defined by a testing table of braking distance on speed, grounds.

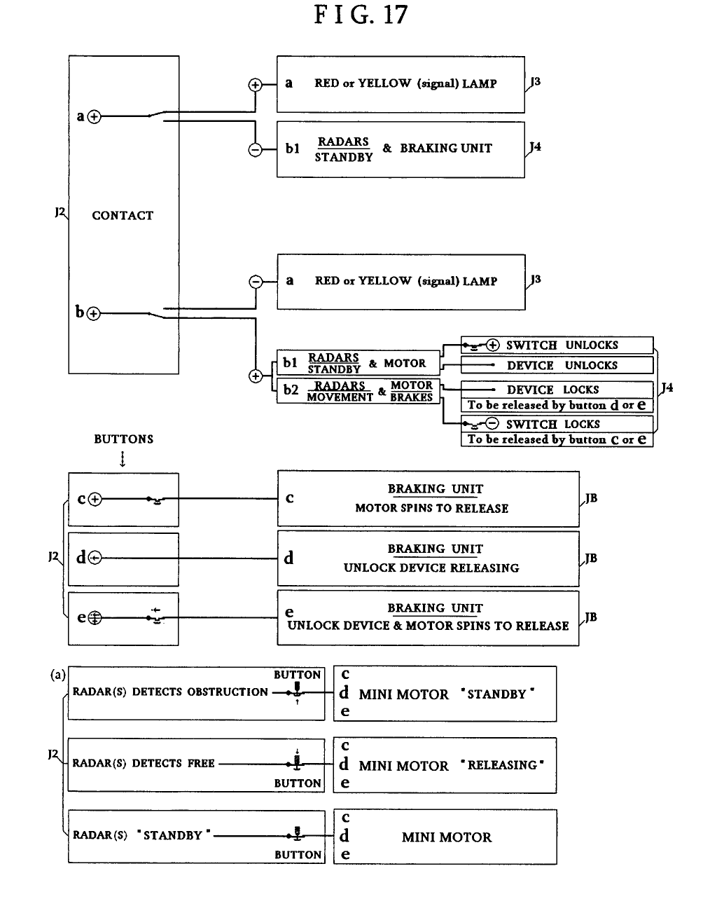

As a part of the invention(s), automatic brake releasing and locking unit: Once obstruction is detected during running, automatic brake locking and releasing in motor-vehicle and transportation are based on comprising (1) sensor(s)/radar(s)/frequency device(s)/similarity reacting automatically both functions of motor braking and pressing button J2c standby for “c” unit, button device J2d standby for “d” unit or button device J2e standby for “e” unit of mini-motor J8 which rotates to draw comprising by cable to unlock lock device resulting from earlier pressing action to release the brake automatically just after sensor(s)/radar(s) detects free J2(a) on FIG. 17, 22, (2) lock device J6; a spring pushing a bar through frame outlet in device, outer part of bar is for locking bracket (of wheel) entering over it to be blockaded therein by spring force, bar end part is fixed with a cable through inner spring from device to mini-motor or driver's contact drawn to release the brake in which button J2c is utilized to switch motor on rotating to release braking unit “c”, button J2d is drawn releasing braking unit “d” and button J2e is for releasing braking unit “e” on FIG. 17, 22 during braking operation. Its connection comprising for (1) key starting contact is connected electric wires through sensor(s)/radar(s)/frequency device(s)/similarity to automatic braking motor and button device of releasing mini-motor, for (2) key starting contact/battery is connected electric wires through button to rotating motor.

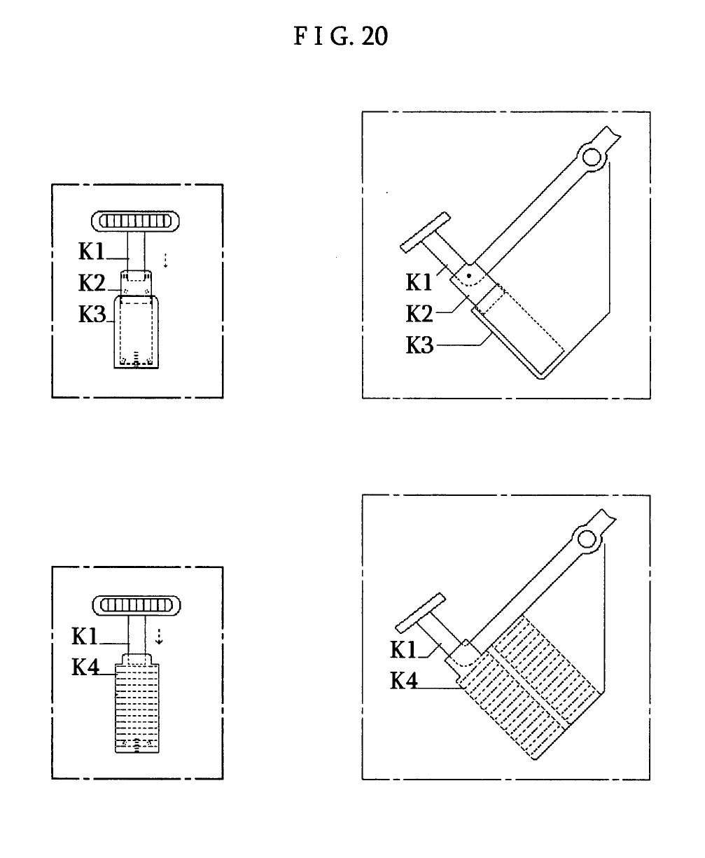

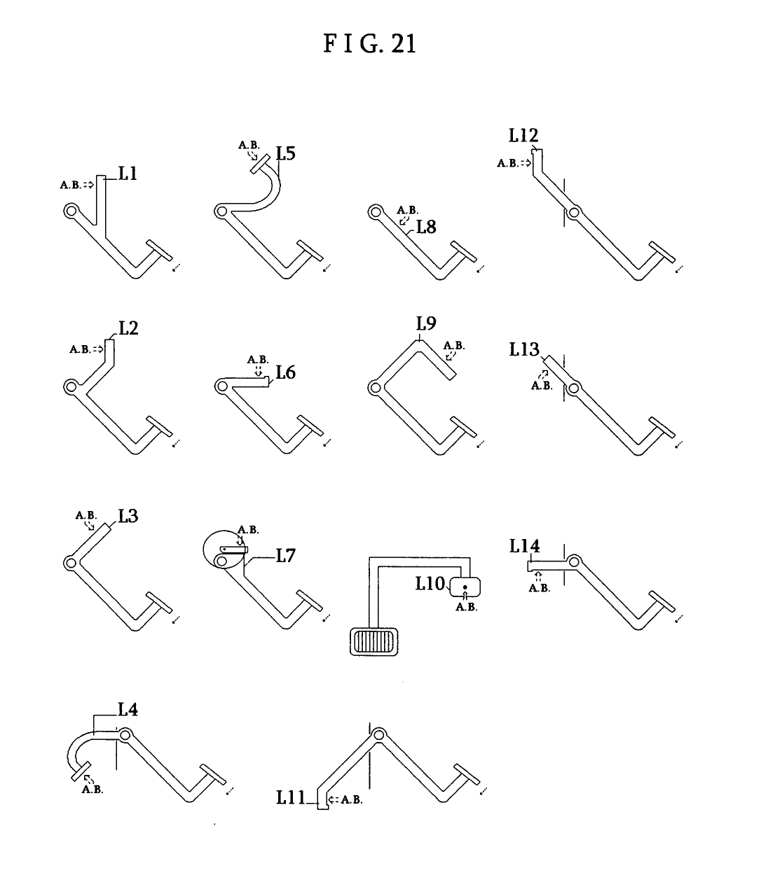

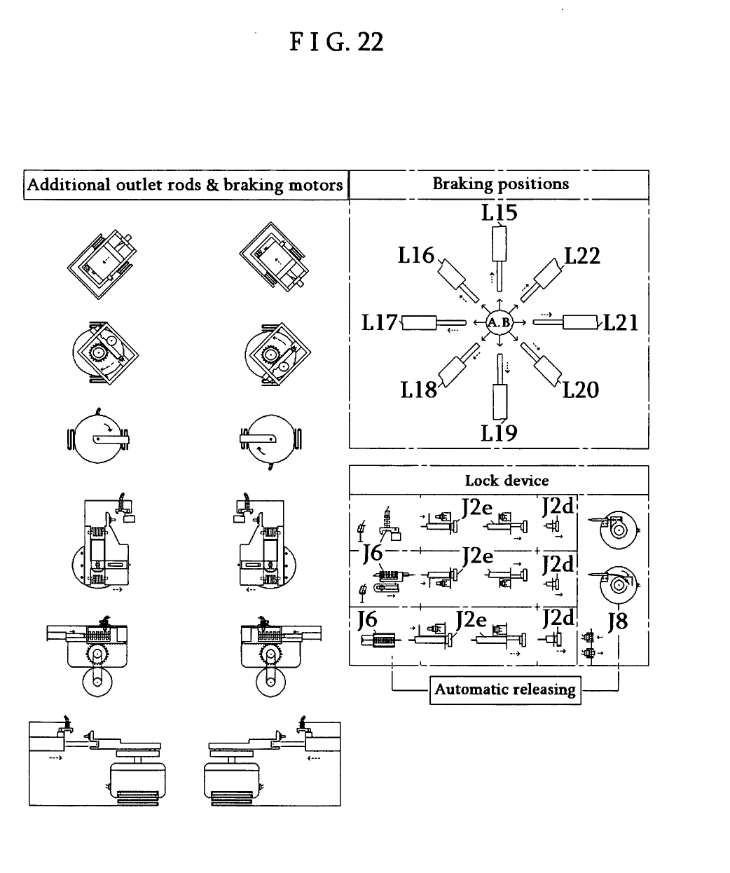

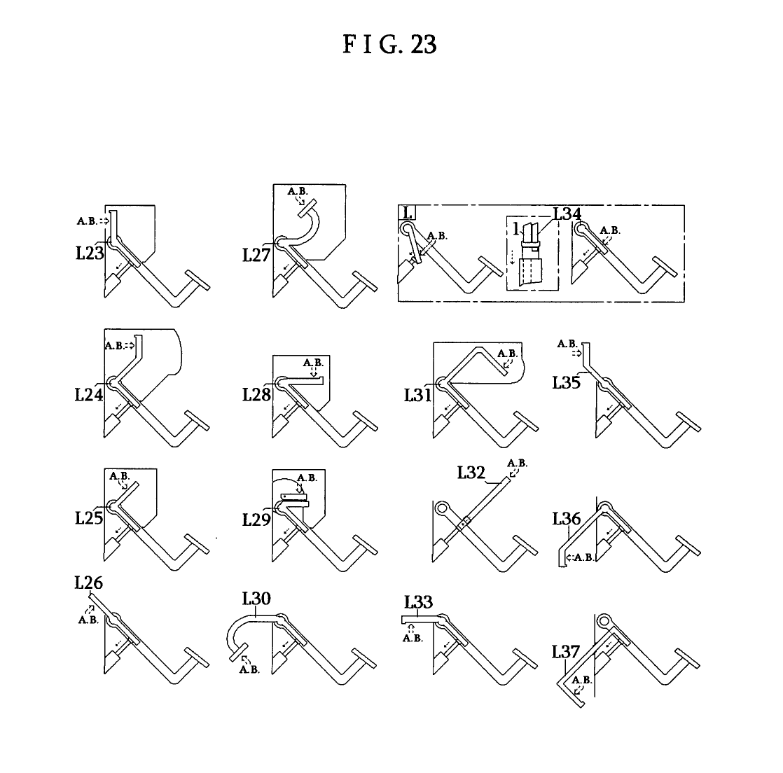

As a part of the invention(s), automatic brake pedals: Automatic brake pedal is used in motor-vehicle, transportation based on comprising using new pedal/upper extension pedal part having rubber boot K4, safety covers K2 and K3 under pedal K1 on FIG. 20. Motor A. B. may be equipped at any position to brake against new pedal from L1 to L14 on FIG. 21 and/or automatic braking pedal has a same axis for movement of both automatic and vehicle brake pedals without causing movement of vehicle pedal L that 15 types of automatic braking pedals provide L23 to L37 on FIG. 23, braking structures by pressing/pulling and/or any other ways grounds. Certain types of braking motor A. B. can well be placed to brake against extra outlet braking rod besides original booster/master cylinder one in a choice of up to eight positions: L15 to L22 on FIG. 22.

As a part of the invention(s), FIG. 16-17 show entire braking system network, electrical circuit of the control unit J5, a diagram of electrical connection of driver contacts J2 to red/yellow signal lamp J3, braking unit JA-JB, braking system standby J4 b1 and braking system movement J4 b2, all are shown separate signal lamps on driver indicator. The entire system comprises to be made in general electrical, technical and mechanical ways of an operative device in motor-vehicle and transportation in which lamps/similarities are connected to show every operation of the invention on indicator(s).

As a part of the invention(s), automatic safety system: Comprising sonorous color signal lamp/voice recorder J3 sounds to driver in motor-vehicle/transportation while entire braking system J4 is “off” on FIG. 19 connected in function of a driver's contact J2b to J2a on FIG. 17 when necessary or driver finds impossible to balance his motor-vehicle/transportation on ice-covered road if braking operates and a thermostat is installed to disconnect sonorous color signal lamp/voice recorder in winter snow on FIG. 19. Its connection comprising key starting contact is connected electric wires through a driver contact to entire braking system and driver contact is connected electric wires through color signal lamp/voice recorder to battery.

Structural automatic braking unit referring to paragraph [0052] is invented as a part of Detectable anti-collision automatic braking device, automatic braking is operated by itself automatically during running based on the result of both operations of sensor(s)/radar(s)/any ready-made operative device(s) being installed detecting against obstacle at its detecting zone and of structural automatic braking unit being installed in/on transportation and connected electrically switching on by sensor(s)/radar(s) that motor-vehicle/transportation is stopped running to avert collision grounds, installing as parts of the invention(s) comprising one(s) of the following automatic braking units of “Triangle wheel, Duo to Duo-J” with structural operation links and parts in function in characteristic process including that:

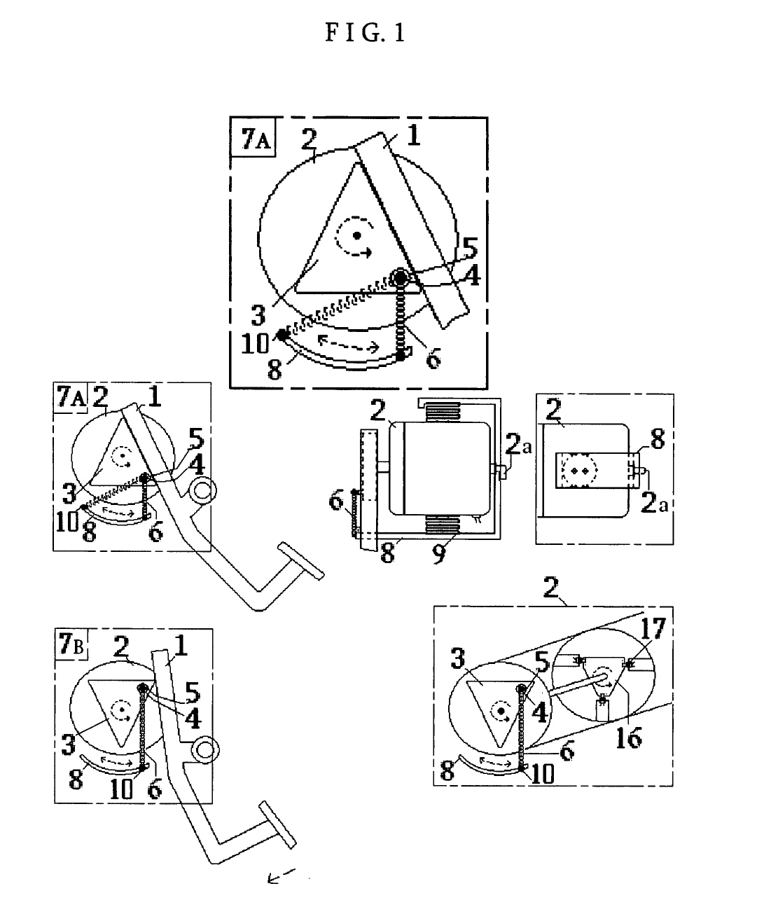

As a part of the invention(s), “Triangle wheel” automatic braking structure and operation unit: 7A automatic braking unit operates based on once obstruction being detected during running, comprising 7B sensor(s)/radar(s)/detectable device(s) is installed in motor-vehicle/transportation switching brake motor 2 on rotating triangle wheel 3 to its edge point pressing at the opposite side of upper pedal 1 to brake, motor is turned off by switch and braking is locked by iron switches 17 of motor to its inner triangle wheel 16. Brake is to be released by a ball bearing 5 with pin 4 being fixed firmly at the surface of wheel 3 nearby its flat part corner where a spring 6 is fixed from pin 4 to a moving ball 10 of motor frame 8 bar pulling the wheel at the right position after each spin so as to unlock the brake pedal, automatic brake releasing or driver's button switch J2c/J2e on FIG. 17 is to rotate motor and pull wheel by spring force. We fix motor 2 between two supporting springs 9 ending with an arm 2a to the frame 8 letting motor move at its specific position on FIG. 1. Its connection comprising key starting contact is connected electric wires through sensor(s)/radar(s)/frequency device(s)/similarity to automatic braking motor with an “off” switch and button device of releasing mini-motor/button to rotating motor.

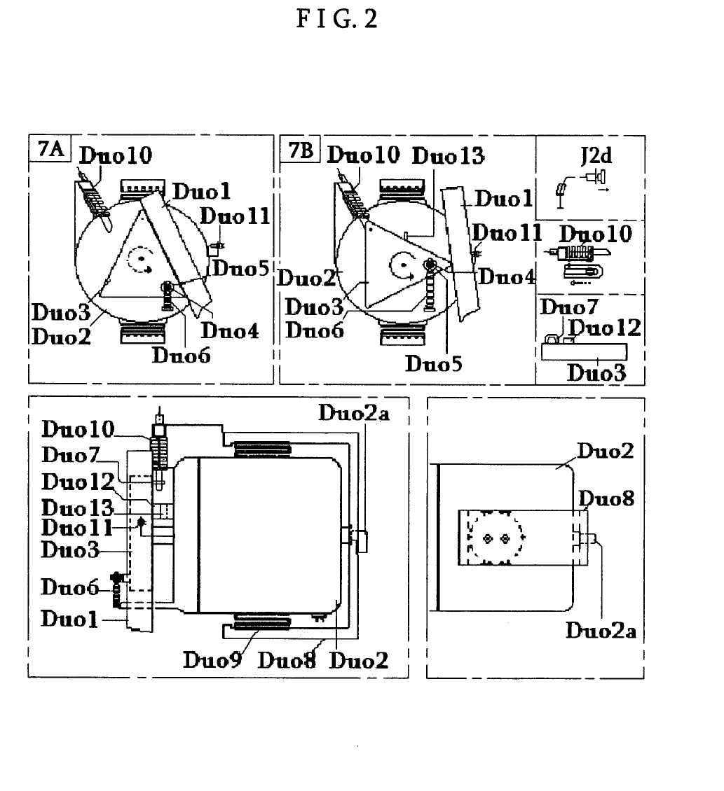

As a part of the invention(s), “Duo” triangle wheel automatic braking structure and operation unit: 7A automatic braking unit operates based on once obstruction being detected during running, comprising 7B sensor(s)/radar(s)/detectable device(s) is installed in motor-vehicle/transportation switching brake motor Duo2 on rotating triangle wheel Duo3 to its edge point pressing at the opposite side of upper pedal Duo1 to brake. Motor is turned off by switch Duo11 against pedal part during braking and braking is locked by lock device Duo10 of motor to bracket arm Duo7. Automatic brake releasing or brake is to be released by driver's button switch J2d rotating wheel to motor iron bar Duo13 blockaded at wheel bracket Duo12 and motor is linked with a spring Duo6 to pull triangle wheel by its pin Duo4 rotating a ball bearing Duo5 for back spin. We fix motor Duo2 between two supporting springs Duo9 ending with an arm Duo2a to the frame Duo8 letting motor move at its specific position on FIG. 2. Its connection comprising key starting contact is connected electric wires through sensor(s)/radar(s)/frequency device(s)/similarity to automatic braking motor with an “off” switch and button device of releasing mini-motor/button to rotating motor.

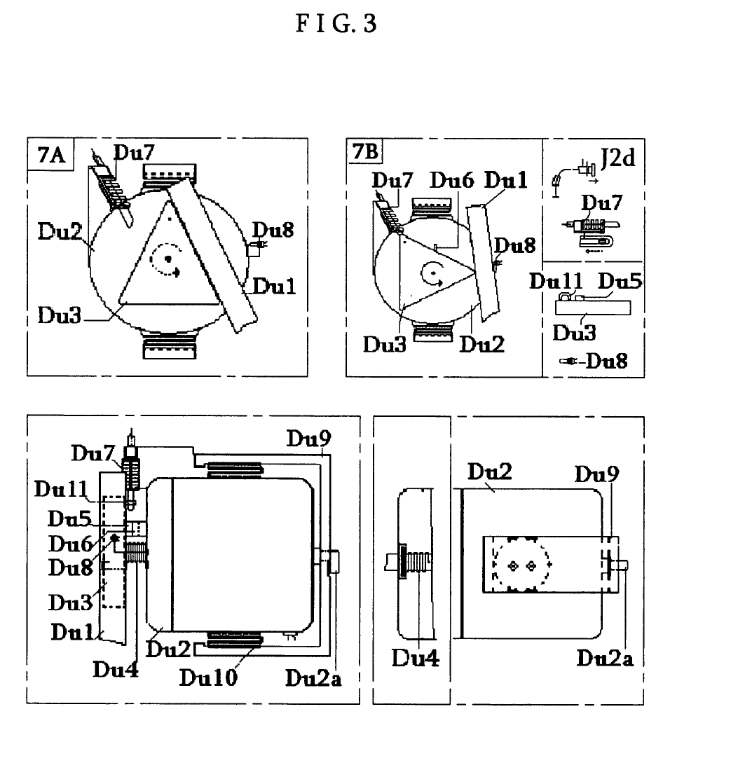

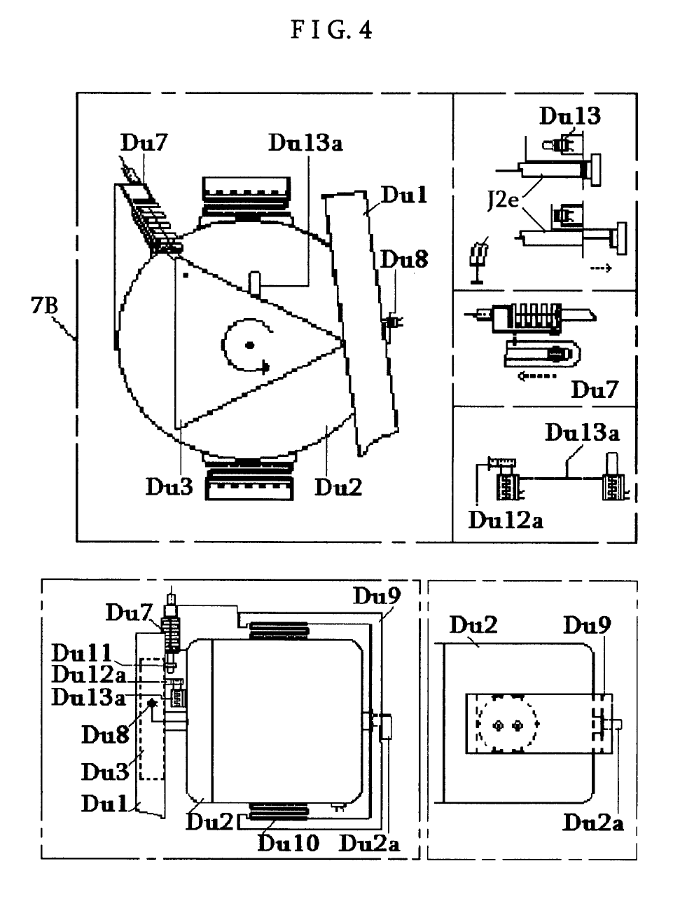

As a part of the invention(s), “Du” triangle wheel automatic braking structure and operation unit: 7A automatic braking unit operates based on once obstruction being detected during running, comprising 7B sensor(s)/radar(s)/detectable device(s) is installed in motor-vehicle/transportation switching brake motor Du2 on rotating triangle wheel Du3 to its edge point pressing at the opposite side of upper pedal Du1 to brake. Motor is turned off by switch Du8 against pedal part during braking and braking is locked by lock device Du7 on motor to wheel bracket arm Du11, automatic brake releasing or driver's button J2d is drawn for releasing brake by outer/inner motor rewind spring Du4 for wheel rotating to blockade wheel arm Du5 to motor bar Du6. FIG. 4; 7B if a double spinning motor is used replacing motor rewind spring, automatic brake releasing or we draw driver's button J2e-Du13 on releasing, wheel bracket Du12a is to be locked at motor switch device Du13a on turning motor at back spin being “off”. We fix motor between two supporting springs Du10 ending with an arm Du2a to the frame Du9 letting motor move at its specific position on FIG. 3-4. Its connection comprising key starting contact is connected electric wires through sensor(s)/radar(s)/frequency device(s)/similarity to automatic braking motor with an “off” switch and button device of releasing mini-motor/button to rotating motor.

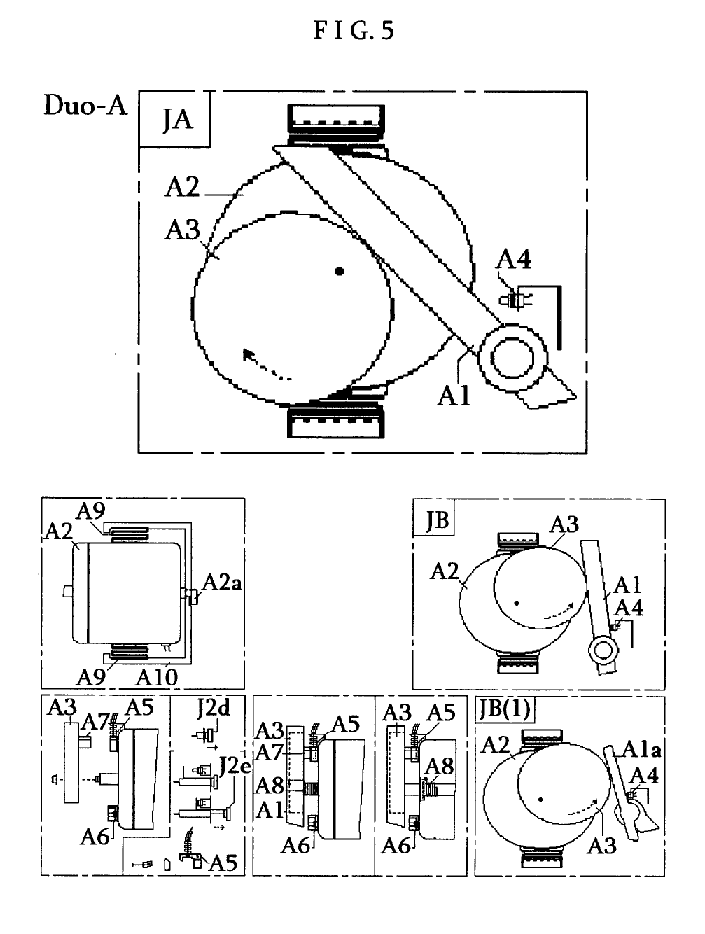

As a part of the invention(s), “Duo-A” round wheel automatic braking structure and operation unit: JA automatic braking unit operates based on once obstruction being detected during running, comprising sensor(s)/radar(s)/detectable device(s) is installed in motor-vehicle/transportation switching brake motor A2 whose axis is fixed between center and rim of a round wheel A3 rotating wheel at summit pushing on pedal part to brake JB or JB(1). Motor is turned off by switch A4 against pedal part during braking and braking is locked by lock device A5 of motor to bracket arm A7 of wheel/lock to locking holes on inner wheel, brake is to be released by driver's button contact J2d and motor rewind spring A8 or using double spinning motor at back spin; it turns one side to brake and the other side to release pedal part A1 or A1a by driver's button J2e rotating wheel to press on switch A6 being “off” or automatic brake releasing. Motor(s) is fixed by two supporting springs A9 in the frame A10, it ends with an arm A2a moving at specific position on FIG. 5. Its connection comprising key starting contact is connected electric wires through sensor(s)/radar(s)/frequency device(s)/similarity to automatic braking motor with an “off” switch and button device of releasing mini-motor/button to rotating motor.

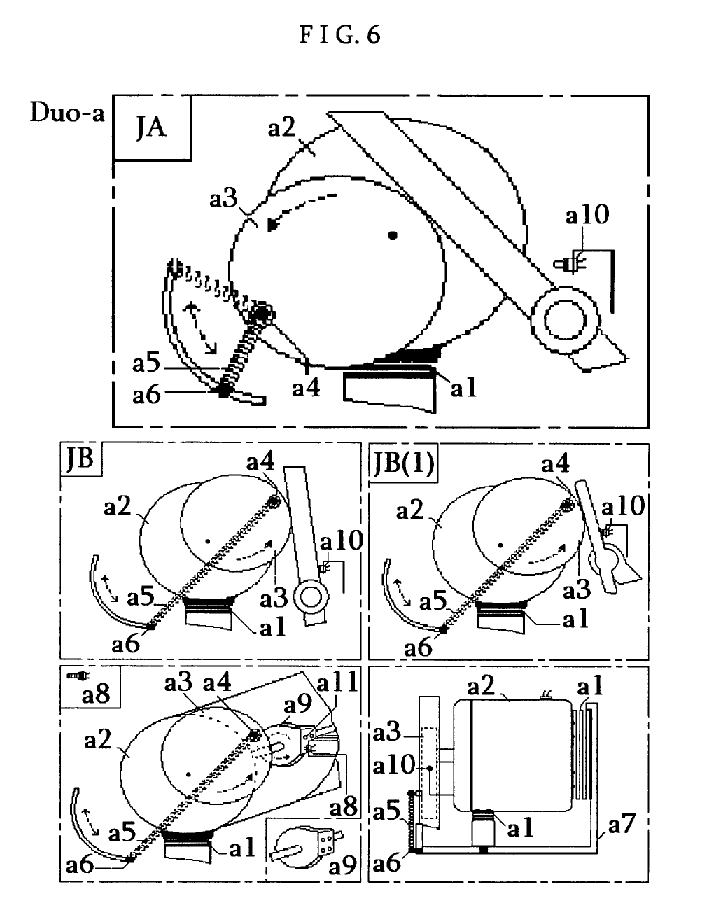

As a part of the invention(s), “Duo-a” round wheel automatic braking structure and operation unit: JA automatic braking unit operates based on once obstruction being detected during running, comprising sensor(s)/radar(s)/detectable device(s) is installed in motor-vehicle/transportation switching brake motor a2 whose axis is fixed between center and rim of a round wheel a3 on rotating wheel at summit pushing on pedal part to brake JB or JB(1). Motor is turned off by switch a10 against pedal part during braking and braking is locked to four locking holes a11 on inner wheel a9 of motor by two lock devices a8 at either first hole line or second line depending on motor rotating at off speed, automatic brake releasing or brake is to be released by driver's button switch J2c on FIG. 17 on rotating motor. A ball bearing with pin a4 is fixed firmly at the surface edge of a round wheel a3 where a spring a5 is fixed from pin of wheel to a moving ball a6 rotating on/in motor frame bar pulling the wheel at the right position to unlock the brake and motor(s) is fixed by two supporting springs a1 in the frame a7 on FIG. 6. Its connection comprising key starting contact is connected electric wires through sensor(s)/radar(s)/frequency device(s)/similarity to automatic braking motor with an “off” switch and button device of releasing mini-motor/button to rotating motor.

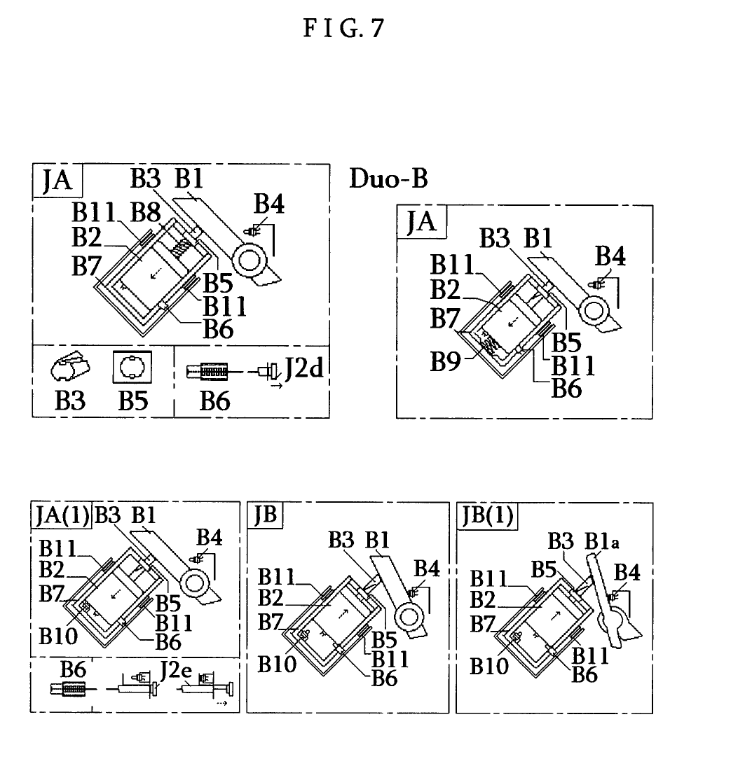

As a part of the invention(s), “Duo-B” screw & unscrew automatic braking structure and operation unit: JA automatic braking unit operates based on once obstruction being detected during running, comprising sensor(s)/radar(s)/detectable device(s) is installed in motor-vehicle/transportation switching brake motor B2 on moving in its frame where its toothed spindle B3 engages through gear-nut B5 of frame B7 in supporting springs B11 to screw out pressing on pedal part B1 at JB/automatic brake pedal B1a at JB(1) or extra outlet rod to brake. Motor is turned off by a switch B4 during braking and braking is locked by lock device B6 frame aside, automatic brake releasing or brake is to be released by driver's button switch J2d and spring force of slotted motor spindle into spring B8/of spring B9 linked motor to the frame. If a double rotating motor is used, automatic brake releasing or driver's contact J2e is to release at return spin, a switch B10 is added letting back spin motor to be off JA(1) on FIG. 7. Its connection comprising key starting contact is connected electric wires through sensor(s)/radar(s)/frequency device(s)/similarity to automatic braking motor with an “off” switch and button device of releasing mini-motor.

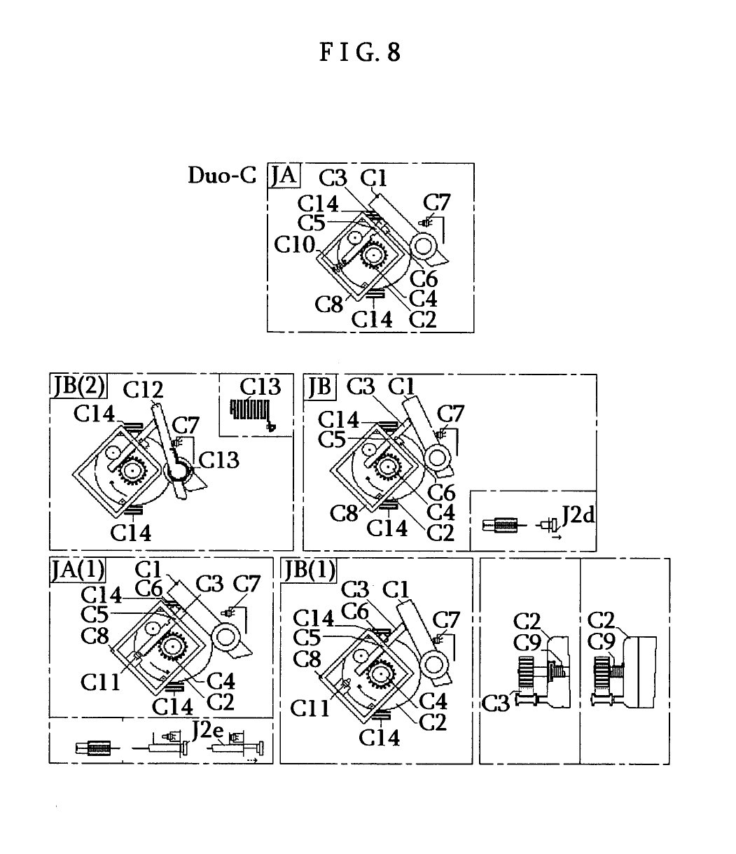

As a part of the invention(s), “Duo-C” axis-gear automatic braking structure and operation unit: JA automatic braking unit operates based on once obstruction being detected during running, comprising sensor(s)/radar(s)/detectable device(s) is installed in motor-vehicle/transportation switching brake motor whose axis C3 engages a tube outlet C5 in frame C8 with its grooved end part rotated by a motor C2 gear C4 moving the axis held by a roller on pressing on pedal part C1 at JB or extra outlet rod to brake. Motor is turned off by switch C7 during braking and braking is locked to axis cavity by lock device C6 fixed on the frame, automatic brake releasing or brake is to be released by driver's button switch J2d and motor rewind spring C9, spring C10 is linked axis end to the frame or rewind spring C13 of automatic brake pedal C12 at JB(2). If we use a double revolving motor, automatic brake releasing or releasing brake is by driver's contact J2e and JA(1), switch C11 is to turn motor off at back spin, motor is installed between supporting springs C14 fixed on frame on FIG. 8. Its connection comprising key starting contact is connected electric wires through sensor(s)/radar(s)/frequency device(s)/similarity to automatic braking motor with an “off” switch and button device of releasing mini-motor.

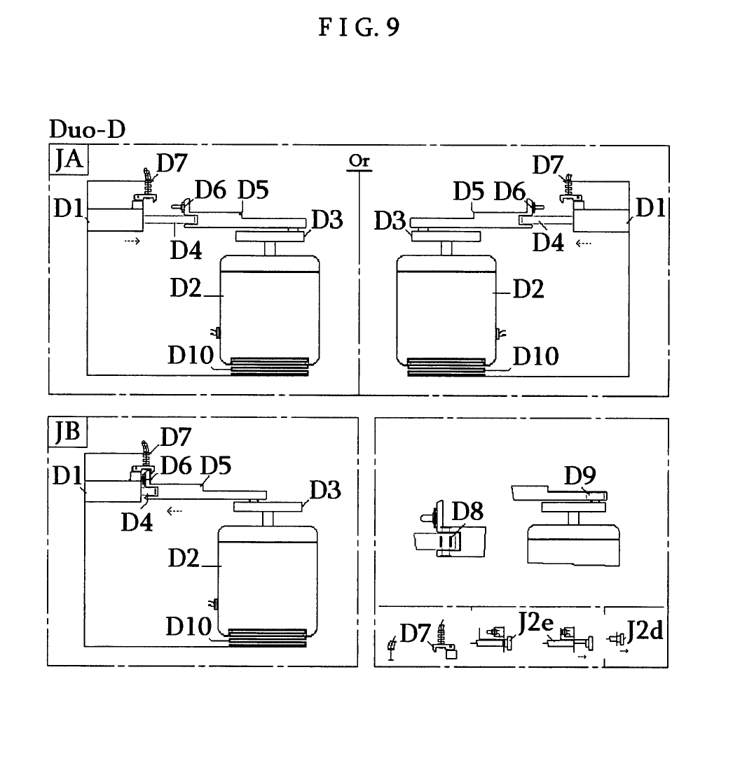

As a part of the invention(s), “Duo-D” extra outlet rod automatic braking structure and operation unit: JA automatic braking unit operates based on once obstruction being detected during running, comprising sensor(s)/radar(s)/detectable device(s) is installed in motor-vehicle/transportation switching a right & left spinning brake motor D2 on for braking, motor is fixed with support spring D10 for its movement, a connecting rod kit D5; its head part is housed a ball bearing D9 rotating with an axis/pin being fixed between center and rim of a round wheel D3 rotated by motor D2, its end part is linked roller D8 and pin to move rod D4 of extra outlet D1 built from original brake booster/master cylinder forward or backward on braking. Motor is turned off by switch D6 fixed on connecting rod hitting against frame during braking and JB braking is locked to connecting rod arm by lock device D7 on frame, automatic brake releasing or brake is to be released by driver's button J2e or J2d using revert spring force for back spin at extra outlet with rod on FIG. 9. Its connection comprising key starting contact is connected electric wires through sensor(s)/radar(s)/frequency device(s)/similarity to automatic braking motor unit with an “off” switch and button device of releasing mini-motor.

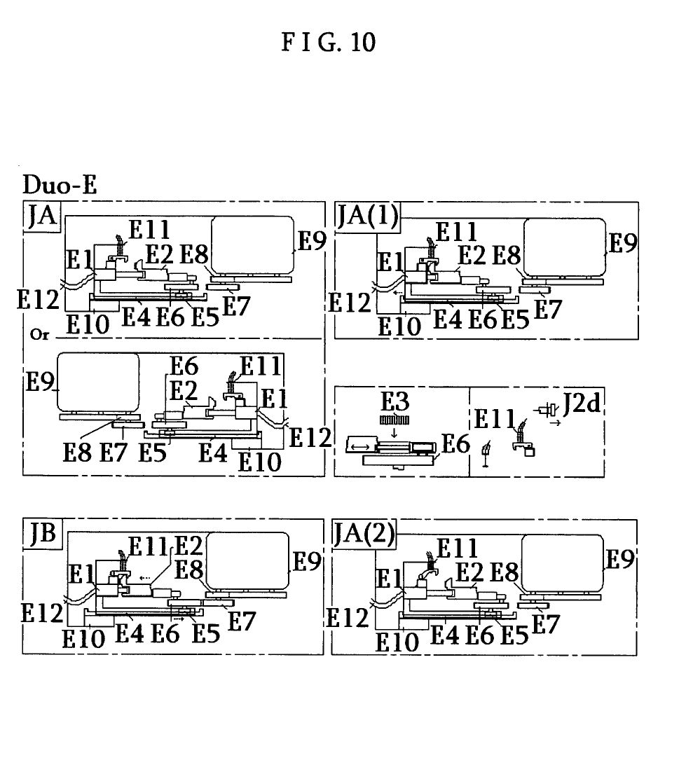

As a part of the invention(s), “Duo-E” moving frame automatic braking structure and operation unit: JA automatic braking unit operates based on once obstruction being detected during running, comprising sensor(s)/radar(s)/detectable device(s) is installed in motor-vehicle/transportation switching oscillator E10 on moving the frame where an extra outlet with rod E1, hose E12 and a connecting rod kit in air releasing spring E3 unit E2; its head part is housed a ball bearing rotating with an axis/pin fixed between center and rim of a round wheel E6 centered to ball bearing E5 on moving frame E4 whose wheel E6 moves to connect JB by pressing on a rubber covered/outer wheel E7 manufactured as a part of double pulley E8 rotated by vehicle/transportation engine E9 for braking replacing a motor. The end part of connecting rod kit unit is linked roller and pin to move rod of extra outlet built from original brake booster/master cylinder forward or backward under spring force. Braking is locked to connecting rod arm by lock device E11 on outlet part, disconnecting JA(1) is to be unlocked JA(2) by driver's contact J2d or automatic brake releasing, fluid pipe needs changing to hose E12 for moving adaptation on FIG. 10. Its connection comprising key starting contact is connected electric wires through sensor(s)/radar(s)/frequency device(s)/similarity to oscillator, automatic braking motor unit and button device of releasing mini-motor.

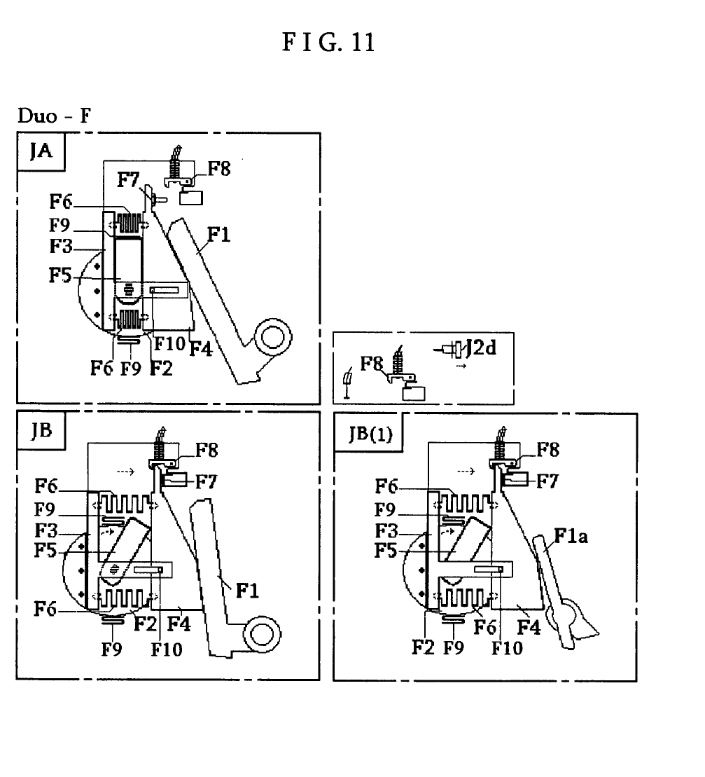

As a part of the invention(s), “Duo-F” bracket drive automatic braking structure and operation unit: JA automatic braking unit operates based on once obstruction being detected during running, comprising sensor(s)/radar(s)/detectable device(s) is installed in motor-vehicle/transportation switching motor F2 with support springs F9 on to drive a rectangular bracket F5 under spring force of two springs F6 being linked their ends from motor frame F3 to a bar/similarity F4 holding a pin F10 moving in the frame cavity, outer bar presses on pedal part F1/automatic brake pedal F1a or extra outlet rod to brake driven by rectangular bracket on motor spin. Motor is turned off by switch F7 fixed on the bar/similarity during braking, and JB or JB(1) braking is locked to bar arm by lock device F8 on the frame, automatic brake releasing or brake is to be released by driver's button switch J2d and spring force on FIG. 11. Its connection comprising key starting contact is connected electric wires through sensor(s)/radar(s)/frequency device(s)/similarity to automatic braking motor unit with “off” switch and button device of releasing mini-motor.

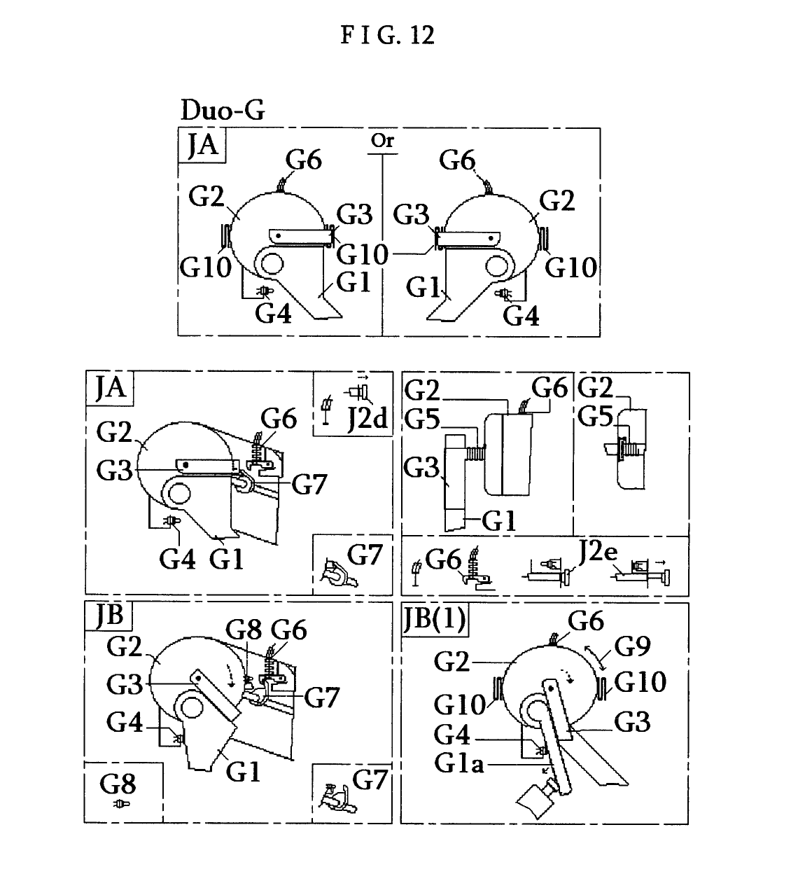

As a part of the invention(s), “Duo-G” direct spin automatic braking structure and operation unit: JA automatic braking unit operates based on once obstruction being detected during running, comprising sensor(s)/radar(s)/detectable device(s) is installed in motor-vehicle/transportation switching adjustable G9 motor G2 in supporting springs G10 on to rotate its bar G3 pressing on pedal part G1/automatic brake pedal G1a JB-JB(1) or extra outlet rod to brake. Motor is turned off by switch G4 nearby the motor and inner wheel G7 of motor axis is locked by lock device G6 inside motor during braking, automatic brake releasing or brake is to be released by driver's button switch J2d and rewind spring G5. If we use a double rotating motor, we release at contact J2e motor back spin to rotate turning itself off by switch G8 on FIG. 12 or automatic brake releasing. Its connection comprising key starting contact is connected electric wires through sensor(s)/radar(s)/frequency device(s)/similarity to automatic braking motor unit with “off” switch and button device of releasing mini-motor.

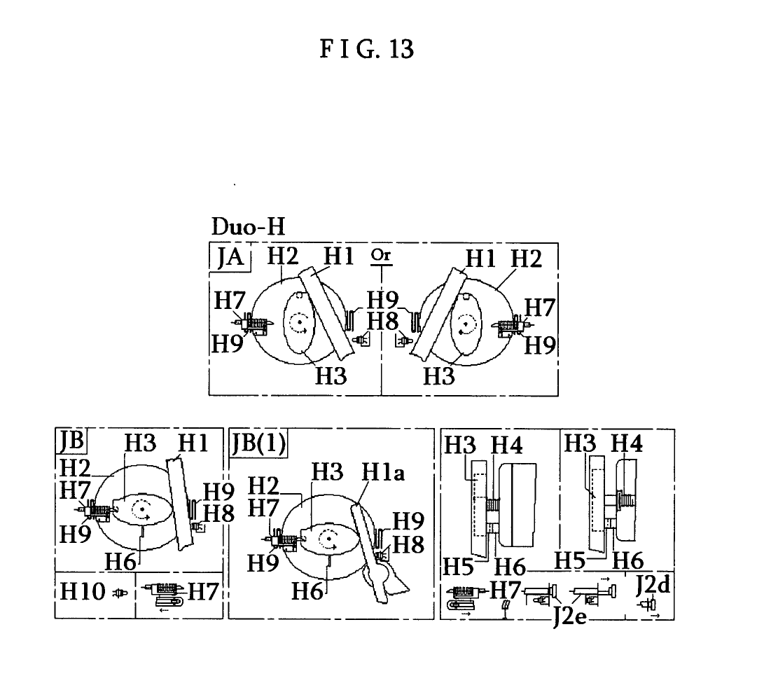

As a part of the invention(s), “Duo-H” oval wheel automatic braking structure and operation unit: JA automatic braking unit operates based on once obstruction being detected during running, comprising sensor(s)/radar(s)/detectable device(s) is installed in motor-vehicle/transportation switching motor H2 with supporting springs H9 on to rotate its oval wheel H3 pressing on pedal part H1 or automatic brake pedal H1a to brake. Motor is turned off by switch H8 at JB or JB(1) and wheel has a bracket arm H5 to blockade itself at motor iron bar H6 and wheel/inner wheel is locked by lock device H7 during braking, automatic brake releasing or brake is to be released by driver's button switch J2d and motor rewind spring H4. If we use a double spinning motor, automatic brake releasing or contact J2e is for releasing and an “off” switch H10 is added to motor bar for back spin on FIG. 13. Its connection comprising key starting contact is connected electric wires through sensor(s)/radar(s)/frequency device(s)/similarity to automatic braking motor with an “off” switch and button device of releasing mini-motor/button to rotating motor.

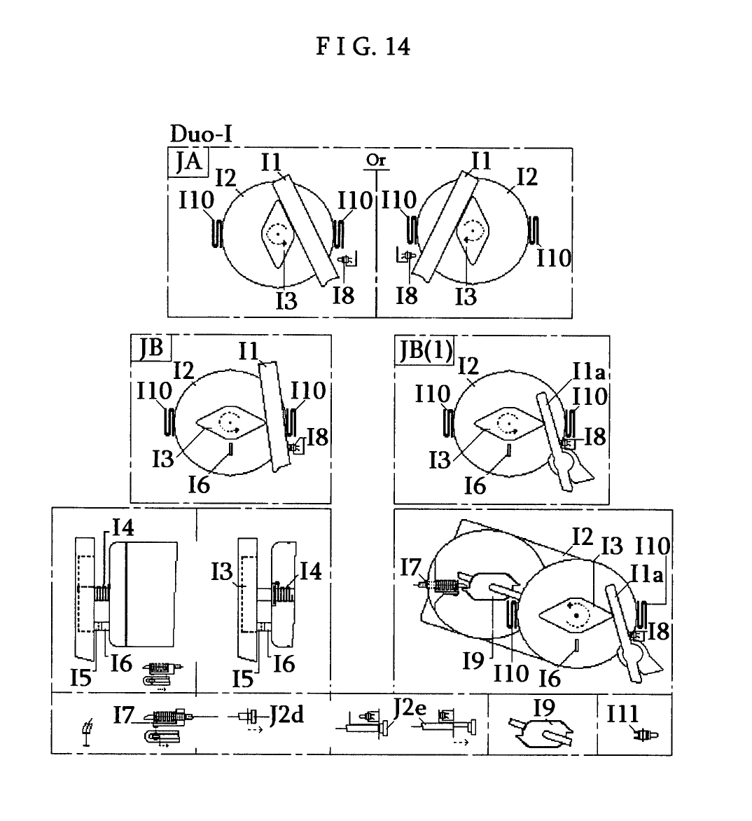

As a part of the invention(s), “Duo-I” hexagonal wheel automatic braking structure and operation unit: JA automatic braking unit operates based on once obstruction being detected during running, comprising sensor(s)/radar(s)/detectable device(s) is installed in motor-vehicle/transportation switching motor 12 with supporting springs 110 on to rotate its hexagonal wheel 13/similarity pressing on pedal part I1 or automatic brake pedal I1a to brake. Motor is turned off by switch I8 at JB or JB(1), and wheel has a bracket arm I5 to blockade itself at motor iron bar I6 and wheel/inner motor wheel I9 is locked by lock device I7 during braking, automatic brake releasing or brake is to be released by driver's button switch J2d and motor rewind spring 14. If we use a double spinning motor, automatic brake releasing or contact J2e is used for releasing and a switch “off” I11 is added to motor bar for back spin on FIG. 14. Its connection comprising key starting contact is connected electric wires through sensor(s)/radar(s)/frequency device(s)/similarity to automatic braking motor with an “off” switch and button device of releasing mini-motor/button to rotating motor.

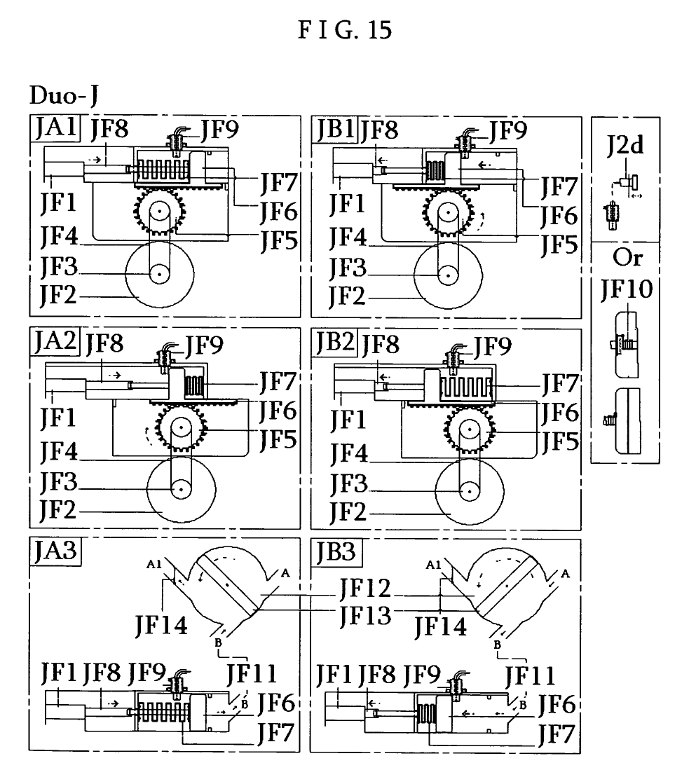

As a part of the invention(s), “Duo-J” air pump automatic braking structure and operation unit: automatic braking unit operates based on once obstruction being detected during running, comprising sensor(s)/radar(s)/detectable device(s) is installed in motor-vehicle/transportation to (1) JA1 switch motor JF2, its pulley JF3 rotates a timing belt JF4 with a gear JF5 unit on grooved part of braking unit JF6, its head part fixed braking rod JF8 of extra brake outlet JF1 for braking JB1 during which it is turned off and locked by lock device JF9, automatic releasing or brake is to be released by a driver contact J2d and bounce spring force JF7 or motor rewind spring JF10, (2) JA2 switch to unlock lock device JF9 letting braking unit JF6 move to brake on linked rod JF8 of extra brake outlet JF1 under spring force JF7 JB2, automatic releasing or brake is to be released by a driver contact J2d and motor JF2 rotating pulley JF3, timing belt JF4, gear JF5 on grooved part of the braking unit JF6, it is turned off and blockaded by switch(es) JF9, and/or (3) JA3 switch mini-motor/similarity to rotate the opening vane JF13 of a valve JF12 letting compressed air JF11 from compressed-air-cylinder, through pipes A, valve unit JF12, pipes B onto press head part of braking unit JF6 in brake cylinder and braking unit end part is linked brake rod JF8 of extra outlet JF1 to brake JB3 during which it is locked by lock device JF9, automatic releasing or brake is to be released by a driver contact J2d, rotating to close vane JF13 of valve unit, unlock lock device and spring force JF7 pushing air through pipe B to valve unit, pipe A1 onto compressed-air-cylinder, pipe A1 has spring cover JF14 on FIG. 15. Its connection; comprising key starting contact is connected electric wires through sensor(s)/radar(s)/frequency device(s)/similarity to automatic braking motor with an “off” switch and button device of releasing mini-motor/button to rotating motor and/or any.

As a part of the invention(s) and paragraph [0071]-(3) air valve unit; air valve unit/cylinder is connected pipes between compressed-air-cylinder and air-braking-pump in which inlet pipe “A” is to let compressed air from compressed-air-cylinder onto valve unit, outlet pipe “A1” having spring cover is to let push compressed air back onto compressed-air-cylinder and pipe “B” is to let compressed air move on braking to air braking pump which will push compressed air back on releasing to compressed-air-cylinder under function of the switching vane of valve unit rotated by mini-motor/similarity on FIG. 15.

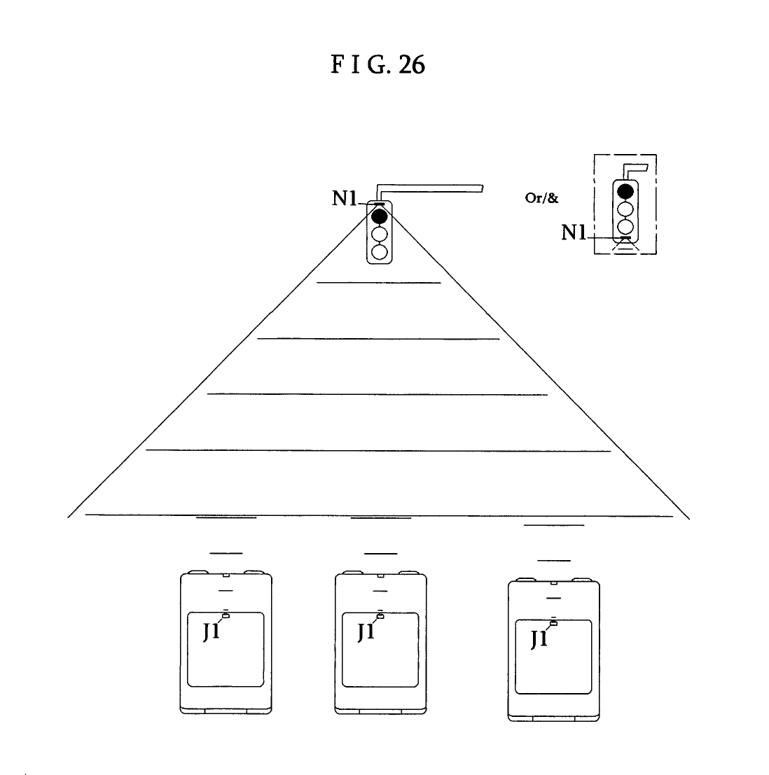

As a part of the invention(s), Automatic traffic stop lamp device N1: It is invented to adapt Detectable anti-collision automatic braking device in use for stopping all front motor-vehicles/transportations on red light based on comprising lamp(s)/bulb(s) being equipped on traffic signal or in area nearby, its beam will flash at lighting zone limit on red at a position to focus on to react the function of front sensor(s)/radar(s) J1 of Detectable anti-collision automatic braking devices in all front motor-vehicles/transportations which approach to stop without surpassing zone on FIG. 26. Its connection; lamp(s)/bulb(s) being equipped on/in traffic signal/area nearby is connected electrically to the red signal lamp in operation.

As a part of the invention(s) and paragraph [0073], comprising lamp(s)/bulb(s) for reacting is installed at traffic pole corners in the intersection in which its beam will flash at opposite motor-vehicle(s) and transportation(s) on stop, to turn right/left toward the street where pedestrian passes on the crossings from one side to the other border, the reacting lamp(s) switches on flashing at these motor-vehicle front sensors/radars whenever sensor/radar on a traffic pole reacts in function against the presence of pedestrian at exact distance where one steps on the street. Its connection; sensor/radar being equipped on a traffic pole is connected electrically to the reacting lamp(s) in its operative system.

As parts of the invention(s), the invention(s) in these documents includes the origin, the base, original idea, basis of invention, grounds, composition, function, structures, method and process of making, inventing, inventing of using, contents, illustrations, connection, extension, electrical circuit wire/wireless connection, combination, operation, installation, production, putting basis of the invention(s) into practice, materializing, using, the invention(s) being manufactured in general electrical, technical and mechanical ways of operative device(s), whole/part of the invention, comprising operating the invention in transportation separately and/or in combination during running, comprising operating electrically, technically and mechanically in its logical order, the specific and extra uses of the invention(s), selling/offering for sale the invention products comprising whole/a part of them, addition/reduction part/unit of the invention, necessary parts, any energy for functioning, any material(s) for making, similarities, imitations, substitutes, any other structures, modifications, replacement of parts being assembled for performing the same/similar devices referring to the original fundamentals of the invention(s) grounds operating to the same/similar effect, equipment/instrument carried by driver/sailor/pilot/others in running transportation operating the invention, comprising using processor, programmer, computer PC, laptop and/or similarity in the invention, using satellite operating network in the invention, any operation affecting the interest of the invention and/or combining the invention with any other entities, devices, equipments, instruments, objects or systems under any names being in the scope of the protection of the invention, using the invention everywhere.

1-4. (canceled)

5. What I claim as my invention is: The basis of inventing and materializing Detectable anti-collision automatic braking device invented for stopping collision/traffic accident in transportation during running; comprising sensor(s)/radar(s)/similarity is for installing in/on engine/motor-vehicles, automobiles, cars, trucks, buses, vans, trains, high speed trains, underground trains, tanks, motorcycles, airplanes, ships, helicopters, submarines and all moving transportations connecting on “standby” for front and rear detecting at specified distance on the road, on railway, on air route and/or at/in sea, automatic braking being operated by itself automatically during running based on both operations of sensor(s)/radar(s)/any operative device(s) detecting against obstacle at its detecting zone and of structural automatic braking unit being installed in/on transportation and connected electrically switching on by sensor(s)/radar(s) that motor-vehicle/transportation being stopped running to avert collision grounds, installing as parts of the invention comprising with detecting device in/on all transportation for safe driving, disconnecting function period, automatic water switch, speedometer switch unit, automatic braking unit(s) & structural operation links, automatic brake locking & releasing unit, automatic brake pedal, automatic safety system, operating lamps/similarities shown on indicator(s) and mechanical & electrical circuit connections in function grounds as well for adapting comprising Automatic traffic stop lamp device in use, including:
basis of inventing and materializing the use of detecting device in/on all transportation for safe driving according to claim 5 in which detectable device(s) installed in transportation for safe driving in characteristic process comprising sensors/radars, infrared detecting lenses, electronic eyes, lighting/motion sensors, video cameras, electromagnetic/radio waves of frequency devices and/or ready-made devices in use having capacity to detect and respond by detected result against obstruction/transmitting & receiving (radio) frequency signals against obstacle under its detecting/operating zone being installed for/on/in motor-vehicle/transportation to switch braking motor/unit on automatically to perform automatic braking during running grounds,
basis of inventing and materializing the use of detecting device in/on all transportation for safe driving according to claim 5 in which detectable device(s) installed in transportation for safe driving in characteristic process comprising sensor(s)/radar(s)/detectable device(s) in use having capacity detecting both vehicle and human body containing anti-snow and anti-light flashing facilities being installed for/on/in motor-vehicle/transportation for front and rear detecting at specified distance functioning during running, which rear sensor(s)/radar(s)/similarity being installed and connected through rear lamp switch being switched on during backing to perform automatic braking against obstacle grounds,
basis of inventing and materializing the use of detecting device in/on all transportation for safe driving according to claim 5 in which detectable device(s) installed in transportation for safe driving in characteristic process comprising motor-vehicle/transportation turning right/left against opposite vehicle to avert front sensor(s)/radar(s) functioning during running comprising either signal lamp switch or a switch at steering wheel being connected for switching front sensor(s)/radar(s) off grounds, or front sensor(s)/radar(s) of adjustable direction mounted/fixed on an axis centered in ball bearing framed in motor-vehicle/transportation, axis part linked gear to gear of steering wheel/its division rotating right or left at its turning direction grounds,
basis of inventing and materializing disconnecting function period of Detectable anti-collision automatic braking device according to claim 5 in which disconnecting functions at starting and parking period of automatic braking in motor-vehicle/transportation in characteristic process comprising speedometer switch being used to disconnect electrically sensor(s)/radar(s)/detectable device(s) operating comprising at lowest speed to let driver of motor-vehicle/transportation both leave parking area and/or park one's vehicle in parking area grounds, or a timer with preset time/manual timing action being connected key contact to postpone sensor(s)/radar(s) functioning in motor-vehicle to that effect grounds,
basis of inventing and materializing automatic water switch according to claim 5 in which automatic water switch connection in characteristic process comprising automatic water switch being installed connecting by raining water in box/container between electric wires of second front sensor(s)/radar(s)/similarity of specified longer distance detection and those of automatic braking unit in motor-vehicle/transportation which to be stopped running on wet earlier against obstacle during raining, extinguishing connection by wind drying water on it after raining as lamp shown on indicator grounds,
basis of inventing and materializing speedometer switch unit comprising operating with (third) front sensor/radar/similarity according to claim 5 in which speedometer used as a switch in characteristic process comprising speedometer pointer conducting comprising electrically indicator front/back surface at high speed as superior to 80/any depending on country law or using sensor/radar to detect speedometer pointer appeared at high speed zone on indicator to react functioning, connecting (third) front sensor/radar/similarity in motor-vehicle/transportation to detect against obstacle at the specified longest distance during running to sonorous signal lamp/voice recorder (1) sounding driver comprising to lower motor-vehicle and/or train speed at the earliest on the road and/or railway to avert automatic braking grounds, (2) sounding pilot/sailor comprising to lower speed airplane, helicopter, ship and submarine changing direction during flying/sailing against obstacle to avert collision at the earliest, other sensor(s)/radar(s)/detectable device(s) installed comprising on top, down and both sides of airplane, helicopter, submarine and both sides of ship for safely detecting during changing direction grounds, and/or (3) using either automatic braking unit or a second braking unit without lock applying braking to lower motor-vehicle/transportation speed grounds, (4) connection; comprising electric wires of one pole of (third) sensor/radar and sonorous signal lamp/voice recorder/automatic braking unit being connected to speedometer pointer and the other pole of them to battery, electric wires of one pole of battery connected to speedometer indicator front/rear surface at high speed zone/any of speedometer switch grounds,
basis of inventing and materializing the use of detecting device in/on all transportation for safe driving according to claim 5 in which detectable device(s) installed in transportation for safe driving in characteristic process comprising (1) sensors/radars being installed at right and left mirror sides of motor-vehicle/transportation for back and aside detecting, connecting signal lamp to switch it on during turning to sonorous signal lamp/voice recorder sounding driver against obstacle during running grounds, (2) sensors/radars/similarities being installed aside of right and left sides comprising at/in each signal lamp box of motor-vehicle/transportation detecting aside person/car approaching while driving out of driveway under function of a switch, connecting sonorous signal lamp indicator/voice recorder to sound driver and/or react automatic braking against obstacle during running grounds,
basis of inventing and materializing the use of detecting device in/on all transportation for safe driving according to claim 5 in which small detectable device(s) installed in transportation for safe driving in characteristic process comprising (1) sensors/radars/similarities being installed at both sides of motor-vehicle and transportation for detecting extremely approaching running vehicles, connecting sonorous signal lamp/voice recorder to sound right or left side under detection during running grounds, (2) sensors/radars/similarities being equipped at rear parts of doors in motor-vehicle/transportation at passenger and driver's sides detecting approaching vehicle for door slightly opening, sonorous lamp/voice recorder connected battery to sound driver, second sensor/radar being installed at door/opposite side on detecting at distance against vehicle chair/frame to switch sensor/radar off without flashing/sounding once door widely opening far beyond detection, using for motor-vehicle parking on the side of the road grounds,
basis of inventing and materializing automatic braking unit(s) & structural operation links according to claim 5 in which structural automatic braking operating links in characteristic process comprising (1) automatic braking operated by appropriate motor, induction coils, air/liquid pump, compressed air/wind force, air hydraulic/oxygen unit, spring force and/or movement caused by any energy/way, (2) braking objects as wheel, spindle, axis, bracket, cylinder as nut and piston as bolt, braking rod, equipment, instrument and/or any structural ways by pressing/pulling to braking outlet rod/extra outlet rod/other similarity, (3) braking pedals as new pedal/upper pedal part (L1 to L14) being prolonged having rubber boot, safety cover and/or automatic braking pedal (L23 to L37) having a same axis for movement of both automatic and vehicle brake pedals without causing movement of each other, and braking positions (L15 to L22), (4) switch for turning brake motor/similarity off at point in braking prior to locking brake, (5) lock device for locking the brake braking firmly to its braking object and/or any, (6) brake released by drawing lock device by a mini-motor rotating automatically/manual button switch to unlock the brake under motor rewind spring, spring, double rotating motor and/or any, (7) braking motor fixed with supporting springs at specific moving position, an appropriate motor rotating to brake fast enough, a double rotating motor having low speed at back spin, (8) entire electrical circuit & mechanical connections being made comprising operating in its logical order and (9) the degree of speed defined by a testing table of braking distance on speed, grounds,
basis of inventing and materializing automatic locking & releasing unit according to claim 5 in which locking & releasing operating during braking of automatic braking device in motor-vehicle/transportation in characteristic process comprising (1) braking lock device during braking comprising a spring pushing a bar through frame outlet in device, outer part of bar for locking bracket (of wheel) entering over it to be blockaded therein by spring force and bar end part being fixed with a cable through inner spring from device to mini-motor or driver's contact by drawing to release the brake grounds, (2) sensor(s)/radar(s)/similarity reacting against obstacle both operating of motor braking and pressing button standby of mini-motor which rotating to draw comprising by cable/similarity to unlock lock device resulting from earlier pressing action releasing the brake automatically just after sensor(s)/radar(s) detecting free grounds,
basis of inventing and materializing automatic safety system according to claim 5 in which automatic safety system of automatic braking device in characteristic process comprising sonorous color signal lamp/voice recorder sounding to driver in motor-vehicle/transportation while entire braking system being “off” connected in function by a driver's contact and a thermostat being installed to disconnect flashing/sounding in winter snow grounds, and lamps/similarities installed showing every operation of the invention(s) on driver's indicator(s) grounds.

6. What I claim as my invention is: The basis of inventing and materializing automatic braking unit(s) & structural operation links are invented as parts of Detectable anti-collision automatic braking device for moving/rotating to brake by itself automatically in motor-vehicle/transportation during running based on both operations of sensor(s)/radar(s)/any operative device(s) installed in/on transportation detecting against obstacle at its detecting zone and of structural automatic braking unit being connected electrically switching on by sensor(s)/radar(s) that motor-vehicle/moving transportation being stopped running to avert collision grounds, installing comprising one(s) of the following structural braking units of “triangle wheel and Duo to Duo-J” being invented in operation, including:
basis of inventing and materializing automatic braking unit(s) & structural operation links according to claim 6 in which automatic braking unit structure and operation of triangle wheels in characteristic process comprising once obstruction being detected during running, sensor(s)/radar(s)/similarity installed in motor-vehicle/transportation switching brake motor on rotating triangle wheel to its edge point pressing on pedal part to brake, motor being turned off by switch and braking locked by motor iron switches to its inner triangle wheel of Triangle wheel structure, or motor lock device to bracket arm in “Duo”, automatic brake releasing or brake to be released by driver's button switch rotating motor wheel blockage or not and pulling wheel by spring force; a ball bearing with pin being fixed firmly at wheel surface nearby its flat part corner where a spring fixed from pin to a moving ball of motor frame bar pulling wheel after each spin to unlock the brake, by rewind spring or double spinning motor in “Du”, grounds,
basis of inventing and materializing automatic braking unit(s) & structural operation links according to claim 6 in which automatic braking unit structure and operation of round wheels in characteristic process comprising once obstruction being detected during running, sensor(s)/radar(s)/similarity installed in motor-vehicle/transportation switching brake motor whose axis fixing between center and rim of a round wheel on rotating wheel at summit pushing on pedal part to brake, motor being turned off by switch and braking locked by lock device of motor to bracket arm of wheel/lock to locking holes on inner wheel, automatic brake releasing or brake to be released by driver's button contact on rotating motor and (1) rewind spring or using double spinning motor in “Duo-A” or (2) pulling wheel by spring; a ball bearing with pin fixed at surface edge of round wheel where a spring fixed from pin to moving ball of motor frame bar pulling wheel to unlock the brake in “Duo-a”, grounds,
basis of inventing and materializing automatic braking unit(s) & structural operation links according to claim 6 in which automatic braking unit structure and operation of screw & unscrew in characteristic process comprising once obstruction being detected during running, sensor(s)/radar(s)/similarity installed in motor-vehicle/transportation switching brake motor on moving its frame; its toothed spindle engaging through gear-nut of frame in supporting springs screwing out pressing on pedal part/extra outlet rod to brake, motor being turned off by switch and braking locked by lock device, automatic brake releasing or brake to be released by driver's button switch and slotted motor spindle spring force, spring linked to frame or double rotating motor in “Duo-B” grounds,
basis of inventing and materializing automatic braking unit(s) & structural operation links according to claim 6 in which automatic braking unit structure and operation of axis-gear in characteristic process comprising once obstruction being detected during running, sensor(s)/radar(s)/similarity installed in motor-vehicle/transportation switching brake motor, an axis engaging a tube outlet of frame with its grooved end part rotated by a motor gear moving the axis held by a roller, pressing on pedal part/extra outlet rod to brake, motor being turned off by switch and braking locked to axis cavity by lock device, automatic brake releasing or brake to be released by driver's button switch and rewind spring/spring force or any in “Duo-C” grounds,
basis of inventing and materializing automatic braking unit(s) & structural operation links according to claim 6 in which automatic braking unit structure and operation of extra outlet in characteristic process comprising once obstruction being detected during running, sensor(s)/radar(s)/operating device(s) installed in motor-vehicle/transportation switching brake motor with support spring, a connecting rod kit; its head part being housed a ball bearing rotating with an axis/pin fixed between center and rim of a round wheel rotated by motor, its end part being linked roller and pin rotating with rod moving forward or backward from an extra outlet built of brake original booster/master cylinder for braking, motor being turned off by switch and braking locked to connecting rod arm by lock device, automatic brake releasing or to be released by driver's button using revert spring force at back spin in “Duo-D” grounds,
basis of inventing and materializing automatic braking unit(s) & structural operation links according to claim 6 in which automatic braking unit structure and operation of moving frame in characteristic process comprising once obstruction being detected during running, sensor(s)/radar(s)/operating device(s) installed in motor-vehicle/transportation switching oscillator on moving a frame where an extra outlet with rod, hose and connecting rod kit in air releasing spring unit; its head part being housed a ball bearing rotating with an axis/pin fixed between center and rim of a round wheel centered to ball bearing on moving frame whose wheel moving to connect by pressing on a rubber covered/outer wheel manufactured as a part of double pulley rotated by vehicle/transportation engine for braking, connecting rod kit end part being linked roller and pin to move rod of extra outlet built from original brake booster/master cylinder forward or backward under spring force, braking being locked by lock device, disconnecting to be unlocked by driver's contact or automatic brake releasing and using fluid hose in “Duo-E” grounds,
basis of inventing and materializing automatic braking unit(s) & structural operation links according to claim 6 in which automatic braking unit structure and operation of bracket drive in characteristic process comprising once obstruction being detected during running, sensor(s)/radar(s)/detectable device(s) installed in motor-vehicle/transportation switching motor on to drive a rectangular bracket under spring force of two springs being linked their ends from motor frame to a bar/similarity holding a pin moving in the frame cavity, outer bar pressing on pedal part/automatic brake pedal or extra outlet rod to brake driven by rectangular bracket on motor spin, motor being turned off by switch and braking locked to bar arm by lock device, automatic brake releasing or brake to be released by driver's button switch and spring force in “Duo-F” grounds,
basis of inventing and materializing automatic braking unit(s) & structural operation links according to claim 6 in which automatic braking unit structure and operation of direct spin in characteristic process comprising once obstruction being detected during running, sensor(s)/radar(s)/detectable device(s) installed in motor-vehicle/transportation reacting to switch motor on rotating its bar pressing on pedal part/extra outlet rod to brake, motor being turned off by switch and inner wheel locked by lock device inside motor during braking, brake releasing automatically or to be released by driver's button switch and rewind spring/double rotating motor with switch off in “Duo-G” grounds,
basis of inventing and materializing automatic braking unit(s) & structural operation links according to claim 6 in which automatic braking unit structure and operation of oval & hexagonal wheels in characteristic process comprising once obstruction being detected during running, sensor(s)/radar(s)/detectable device(s) installed in motor-vehicle/transportation reacting to switch motor on rotating its oval/hexagonal wheel or similarity pressing on pedal part/extra outlet rod to brake, motor being turned off by switch and braking locked at wheel having a bracket arm to blockade itself at motor iron bar or inner motor wheel locked by lock device during braking, brake releasing automatically or to be released by driver's button switch and rewind spring/double rotating motor with switch off in “Duo-H, I” grounds, and/or
basis of inventing and materializing automatic braking unit(s) & structural operation links according to claim 6 in which automatic braking unit structure and operation of air pumps in characteristic process comprising once obstruction being detected during running, sensor(s)/radar(s)/detectable device(s) installed in motor-vehicle/transportation reacting to: (1) switch motor; its pulley rotating a timing belt with a gear unit on grooved part of braking unit, its head part fixed braking rod of extra brake outlet for braking during which being turned off and locked by lock device, brake releasing automatically or to be released by a driver contact and bounce spring force or motor rewind spring in “JA1 of Duo-J” grounds, (2) switch to unlock lock device letting braking unit move to brake on linked rod of extra brake outlet under spring force, brake releasing automatically or to be released by a driver contact and motor rotating pulley, timing belt, gear on grooved part of braking unit to be turned off and blockaded by lock switch(es) in “JA2 of Duo-J” grounds and/or (3) switch mini-motor/similarity in a valve rotating its opening vane letting compressed air from compressed-air-cylinder, through pipe “A”, valve unit, pipe “B” onto press on head part of braking unit in brake cylinder and end part of braking unit linked rod of extra brake outlet to brake during which being locked by lock device, brake releasing automatically or to be released by a driver contact, rotating to close vane of valve unit, unlock lock device and spring force pushing air through pipe “B”, valve unit, pipe “A1” onto compressed-air-cylinder, pipe “A1” having spring cover in “JA3 of Duo-J” grounds, and (4) air valve unit/cylinder as a switch to switch incoming/outgoing air under function of braking pump on braking or releasing rotated by mini-motor/similarity in which air valve unit/cylinder being connected pipes between compressed-air-cylinder and air-braking-pump in which inlet pipe “A” letting compressed air from compressed-air-cylinder onto valve unit, outlet pipe “A1” having spring cover letting push compressed air back onto compressed-air-cylinder and pipe “B” letting compressed air move on braking to air braking pump which pushing compressed air back on releasing to compressed-air-cylinder under function of the switching vane of valve unit rotated by mini-motor/similarity grounds.

7. What I claim as my invention is: The basis of inventing and materializing Automatic traffic stop lamp device is invented for adapting Detectable anti-collision automatic braking device in use for stopping all front motor-vehicles and transportations on red light based on comprising lamp(s)/bulb(s) being equipped on traffic signal or in area nearby, its beam flashing at lighting zone limit on red at a position to focus on and reacting the function of sensor(s)/radar(s)/similarity of Detectable anti-collision automatic braking devices on all front motor-vehicles and transportations which approaching to stop without surpassing limit zone grounds, and comprising lamp(s)/bulb(s)/similarity for reacting being installed at traffic pole corners in the intersection in which lamp beam flashing at opposite motor-vehicles and transportations on stop, to turn right/left toward the street where pedestrian passing on the crossings from one side to the other border, the reacting lamp(s) turning on flashing at these motor-vehicle front sensors/radars whenever sensor/radar (connecting to reacting lamp) of a traffic pole reacting in function against the presence of pedestrian at exact distance where one stepping on the road grounds.

8. What I claim as my invention is: As parts of the invention(s), the claims and invention(s) in these documents include the origin, original idea, basis of invention, grounds, composition, function, structures, method and process of making, inventing, inventing of using, contents, illustrations, connection, extension, electrical circuit wire/wireless connection, combination, operation, installation, production, whole/part of the invention, putting basis of the invention(s) into practice, materializing, using, the invention(s) being manufactured in general electrical, technical and mechanical ways of operative device(s), comprising operating the invention in transportation separately and/or in combination during running, comprising operating electrically, technically and mechanically in its logical order, the specific and extra uses of the invention(s), selling/offering for sale the invention products comprising whole/a part of them, addition/reduction part/unit of the invention, any energy for functioning, any material(s) for making, similarities, imitations, substitutes, necessary parts, any other structures, modifications, replacement of parts being assembled for performing the same/similar devices referring to the original fundamentals of the invention(s) grounds operating to the same/similar effect, equipment/instrument carried by driver/sailor/pilot/others operating the invention in running transportation, comprising using processor, programmer, computer PC, laptop and/or similarity in the invention, using satellite operating network in the invention, any operation affecting the interest of the invention and/or combining the invention with any other entities, devices, equipments, instruments, objects or systems under any names being in the scope of the protection of the invention, using the invention everywhere.
